(19) United States
(12) Patent Application Publication
(10) Pub. No.: US 2018/0195197 A1
(43) Pub. Date: Jul. 12, 2018

(54) NANOSTRUCTURED ELECTRODES AND METHODS FOR THE FABRICATION AND USE

(71) Applicant: The Board of Trustees of The University of Alabama, Tuscaloosa, AL (US)

(72) Inventors: Shanlin Pan, Tuscaloosa, AL (US); Zhichao Shan, Tuscaloosa, AL (US); Arunava Gupta, Tuscaloosa, AL (US); Archana S. Panikar, Tuscaloosa, AL (US)

(21) Appl. No.: 15/914,086

(22) Filed: Mar. 7, 2018

Related U.S. Application Data
(63) Continuation of application No. 14/623,101, filed on Feb. 16, 2015.
(60) Provisional application No. 61/939,871, filed on Feb. 14, 2014.

(51) Int. Cl. C25D 11/34; H01M 4/04; C25D 11/26; B82B 3/00; B82Y 40/00

(52) U.S. Cl. CPC C25D 11/34; H01M 4/0428; C25D 11/26; H01M 4/045; Y10S 977/843; B82B 3/0038; B82Y 40/00; B82B 3/008; H01M 4/0471

(57) ABSTRACT

Disclosed herein are methods for forming carbon-modified nanostructured titanium-based materials, nanostructured electrodes, and nanostructured catalysts. Also disclosed herein are methods of use of the carbon-modified nanostructured titanium-based materials, nanostructured electrodes and nanostructured catalysts described herein.

### CROSS-REFERENCE TO RELATED APPLICATIONS

This application claims benefit of U.S. Provisional Application No. 61/939,871, filed Feb. 14, 2014, which is hereby incorporated herein by reference in its entirety.

### STATEMENT OF GOVERNMENT SUPPORT

This invention was made with government support under Grant No. CHE-1153120 awarded by the National Science Foundation. The government has certain rights in this invention

### BACKGROUND

Hydrogen is the most abundant element in the universe, composing 75% of all elemental matter in the universe. However, the majority of hydrogen is contained within compounds which cannot be directly used as energetic fuel. In its molecular element form, hydrogen can find use in applications such as fuel cells, chemical syntheses (e.g., ammonia production for fertilizers and hydrocracking processes in petroleum industry for fuels), and massive energy production system energy sources. Water is the only byproduct when hydrogen is used as a fuel. This is one of major advantages that hydrogen possesses as an energy storage material in contrast to hydrocarbon fuels such as gasoline and diesel which produce carbon monoxide and carbon dioxide that contribute to climate change, and possible toxic compounds (e.g., carbon monoxide, nitrogen oxides, and hydrogen sulfide).

Today, about 9 million tons of hydrogen is produced annually and 95% of this production volume is used in industrial applications for chemical, metals, electronics, and space projects. Conventional technologies used for hydrogen production include steam-reformation of carbon hydride (e.g., methane), closed-cycle thermochemical decomposition of water, and thermonuclear fusion. The steam methane reforming method accounts for 80% of the hydrogen produced while 20% is a by-product of chemical processes. Electrolysis of water has been proven to be a reliable technique suitable for both small and large hydrogen production units. Electrolysis of water also holds the promise to efficiently produce high-pressure hydrogen gas without using an expensive compression step. Yet water electrolysis represents only a small portion of the total hydrogen production; one of the major obstacles to widespread adoption is the high cost of the energy sources used to power the electrolysis process. The production of hydrogen fuel by water electrolysis is also limited by the low efficiency of the water-splitting catalysts and high capital costs of electrode materials of noble metals such as platinum (Pt). The oxygen evolution reaction (OER, 2H₂O→O₂+4H⁺+4e⁻ in acid; 4OH⁻−4e⁻→O₂↑+2H₂O in alkaline solution) and proton reduction reaction (PRR, 2H⁺+2e⁻→H₂↑) for complete water splitting are kinetically unfavorable at other electrode materials. Thus there has been an enormous amount of research effort in identifying alternative catalytic materials for efficient and cost effective water electrolysis systems.

### SUMMARY

Disclosed herein are methods for forming carbon-modified nanostructured titanium-based materials. The methods for forming the carbon-modified nanostructured titanium-based material can comprise, for example, contacting an iron impregnated nanostructured titanium substrate with a working gas at a working temperature.

In some embodiments, the method can further comprise contacting a nanostructured titanium substrate with an iron catalyst precursor to form the iron impregnated nanostructured titanium substrate.

The nanostructured titanium substrate can comprise a plurality of nanostructures, such as, for example, nanowires, nanotubes, nanochannels, nanopores, or a combination thereof. In some examples, the nanostructured titanium substrate comprises a plurality of nanowires, nanotubes, or combinations thereof on a titanium substrate. In some embodiments, the nanostructured titanium substrate comprises a plurality of nanopores in a titanium substrate. In some embodiments, the nanostructured titanium substrate can comprise nanoparticles comprising titanium, for example TiO₂ nanoparticles (e.g., particles of TiO₂ with an average largest dimension of 2 μm or less).

In some examples, the iron catalyst precursor can comprise Fe(NO₃)₃, ferrocene carboxylic acid, or combinations thereof. In some examples, the iron catalyst precursor can comprise Fe(NO₃)₃.

The working gas can comprise, for example, a hydrocarbon gas. In some examples, the working gas can comprise xylene, ethylene, acetylene, ethane, methane, benzene, toluene, or combinations thereof. In some examples, the working gas comprises methane. In some examples, the working gas can be flowed at a rate of 10-200 sccm. In some examples, the working gas can be flowed at a rate of 60 sccm. In some examples, the working temperature can be 800-1000° C.

In some examples, the method can further comprise thermally annealing a nanostructured titanium substrate and contacting the nanostructured titanium substrate with an iron catalyst precursor to form the iron impregnated nanostructured titanium substrate. Thermally annealing the nanostructured titanium substrate can comprise contacting the nanostructured titanium substrate with an annealing gas at an annealing temperature.

In some examples, the method can further comprise thermally annealing the iron impregnated nanostructured titanium substrate. Thermally annealing the iron impregnated nanostructured titanium substrate comprises contacting the iron impregnated nanostructured titanium substrate with an annealing gas at an annealing temperature.

The annealing gas can be, for example, air. The annealing temperature can be any temperature sufficient to improve the properties of the nanostructured titanium substrate, for example, 450° C. In some examples, the nanostructured titanium substrate is contacted with the annealing gas for 1 hour or more.

Disclosed herein are methods for forming nanostructured electrodes. In some embodiments, the method comprises thermally annealing a nanostructured titanium substrate. In some examples, the thermal annealing of the nanostructured titanium substrate comprises contacting the nanostructured titanium substrate with an annealing gas at a third elevated temperature. The annealing gas can be, for example, air. The third elevated temperature can be, for example, 450° C. In some examples, the nanostructured titanium substrate is contacted with the annealing gas for 10 hours.

In some embodiments, the method further comprises contacting the nanostructured titanium substrate with an iron catalyst precursor to create an iron impregnated nanostructured titanium substrate. In some examples, the iron catalyst precursor comprises Fe(NO₃)₃, ferrocene carboxylic acid, or combinations thereof.

In some embodiments, the method further comprises contacting the iron impregnated nanostructured titanium substrate with a working gas at a first elevated temperature. The working gas can comprise, for example, a hydrocarbon gas, such as methane. In some examples, the first elevated temperature can be 800-1000° C.

In some embodiments, the method further comprises contacting a titanium substrate with an acid at a second elevated temperature to form a nanostructured titanium substrate. In some examples, the acid comprises an aqueous solution of HCl. In some examples, the aqueous solution of HCl comprises 2-3% HCl by weight. In some examples, the titanium substrate is contacted with the acid for 12 hours. In some examples, the second elevated temperature is 190° C. In some examples, the nanostructured titanium substrate comprises a plurality of nanowires, nanotubes, or combinations thereof on the titanium substrate. The nanowires, nanotubes, or combinations thereof can be, for example, 50-100 nm in diameter. The nanowires, nanotubes, or combinations thereof can be, for example, 50-500 nm in length.

In some embodiments, the method further comprises contacting a titanium substrate with an anodization solution and applying a potential to the titanium substrate to form a nanostructured titanium substrate. In some examples, the anodization solution comprises fluoride ions, such as from ammonium fluoride. In some examples, the anodization solution further comprises ethylene glycol. In some examples, the potential can be 20-60 V. In some examples, the potential is applied for 1 hour. In some embodiments, the nanostructured titanium substrate comprises a plurality of nanopores in the titanium substrate. In some examples, the nanopores can be 60 nm in diameter.

Also disclosed herein are methods for forming nanostructured catalysts. The methods can comprise, for example, contacting a nanostructured titanium substrate with an iron catalyst precursor to create an iron impregnated nanostructured titanium substrate. The nanostructured titanium substrate can comprise, for example, a plurality of nanoparticles comprising titanium, for example TiO₂ nanoparticles (e.g., particles of TiO₂ with an average largest dimension of 2 μm or less). In some embodiments, the method can further comprise thermally annealing the iron impregnated nanostructured titanium substrate. In some embodiments, the method can further comprise contacting the iron impregnated nanostructured titanium substrate with a working gas at a working temperature, thereby creating the nanostructured catalyst. In some examples, the nanostructured catalyst can comprise titanium, carbon and oxygen. The ratio of Ti:C:O can, for example, be 1:0.3:1.9.

The nanostructured catalysts can, in some examples, be used as an electrode (e.g., a nanostructured electrode). In some example, a glassy carbon electrode can be loaded with the nanostructured catalyst, for example to make a nanostructured electrode. The electrode comprising the nanostructure catalyst (e.g., the nanostructured electrode) can, for example, be used in a water splitting reaction, in a solar cell, in a charge storage device, or a combination thereof.

Also disclosed herein are methods of use of the nanostructured electrodes described herein as an electrode in a water splitting reaction. Also disclosed herein are methods of use of the nanostructured electrodes described herein as an electrode in a solar cell. Also disclosed herein are methods of use of the nanostructured electrodes described herein as an electrode in a charge storage device.

Additional advantages will be set forth in part in the description that follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DESCRIPTION OF FIGURES

FIG. 1 displays a schematic of the fabrication of a nanostructured carbon doped Ti oxide electrode (NanoCOT).

FIG. 2 displays typical SEM images (B is a more zoomed in image of A) of an anodized Ti substrate at 40 V in ethylene glycol containing 2% H₂O (w/w) and 0.3% NH₄F (w/w). (B) displays a close up view of the sample in (A).

FIG. 3 displays (A) SEM image of a Nano-COT electrode prepared by anodizing a 99.6% pure Ti plate electrode. (B) A zoom-in SEM image of Nano-COT electrode. (C) SEM image of the cross section of a Nano-COT electrode prepared from a 99% pure Ti starting material, and (D) high resolution TEM image of the nanostructured Nano-COT top layer transferred onto a TEM grid.

FIG. 4 displays (A) SEM image of a Nano-COT electrode made by anodizing a 99% pure Ti plate electrode. (B) Image of a bare TiO₂ template made by anodizing a 99% pure Ti plate and annealing under nitrogen protection at 1000° C. (C) Corresponding Raman spectra of Nano-COT electrode and thermal annealed bare TiO₂ anodic template.

FIG. 5 displays the XRD spectrum of (A) a Nano-COT electrode made from 99% Ti in comparison to (B) a bare TiO₂ template annealed at 1000° C. in nitrogen atmosphere.

FIG. 6 displays the CVs of a bare Ti plate, anodized TiO₂ plate, Nano-COT in 1.0M Na₂SO₄ containing (A) 5.0 mM K₃Fe(CN)₆, and (B) 5.0 mM K₃Ru(NH₃)₆ in comparison to redox behavior at a gold disc electrode. Scan rate: 100 mV/sec. (C) scan rate dependence of CVs at a Nano-COT in 1M Na₂SO₄ containing 5.0 mM K₃Fe(CN)₆, and (D) 1.0M Na₂SO₄ containing 5.0 mM K₃Ru(NH₃)₆. Insets of C-D are the cathodic peak current plotted against the square root of scan rate data and linear fitting results. Gold disc electrode diameter: 2.0 mm.

FIG. 7 displays the simulated CV of Nano-COT nanotube electrode with geometric surface area of 0.25 mm² in comparison to experimental CVs collected in 5.0 mM K₃Ru(NH₃)₆ at various scan rates from 10 mV/sec to 2 V/sec. Simulation parameters: D_{O}=D_{R}=8.0×10⁻⁶ cm²/sec; K₀=100 cm/sec; A=0.70 cm²; Ru (Ohmic drop)=10 Ohms; C_{dl}=0.0012 F.

FIG. 8 displays cyclic voltammograms of a Nano-COT substrate at each stage of its fabrication in 0.1M NaOH, including bare Ti substrate, anodized Ti substrate, anodized Ti without a barrier layer annealed at 450° C., and carbon modified TiO₂. The inset contains photos of actual samples including (from left to right) bare Ti, anodized TiO₂ and Nano-COT.

FIG. 9 displays cyclic voltammograms of a Nano-COT electrode in 0.1M tetrabutylammonium hexafluorophosphate (TBAHFP) acetonitrile solution at a scan rate of 0.1 V/sec in comparison with the CVs of TiO₂ coated Ti electrode and bare Ti planar electrode.

FIG. 10 displays a (A) schematic of a pair of Nano-COT electrodes in a symmetric configuration for testing their double layer charging performance. (B) Double layer charging storage performance of a pair of Nano-COT electrode parallel to each other with distance of 0.4 mm to each other in 1.0M NaOH.

FIG. 11 displays the (A) CV and (B) electrogenerated chemiluminescence (ECL) at a nanostructured Nano-COT electrode in phosphate buffer (pH=7.0) containing 25.0 μM Ru(bpy)₃²⁺ and 0.1M coreactant tripropylamine (TrPA), in comparison to that of a bare Ti plate electrode, and an anodized Ti template annealed at 450° C. in air. Scan rate: 100 mV/sec.

FIG. 12 displays the stepwise potential response of the electrogenerated chemiluminescence (ECL) in phosphate buffer (pH=7.0) containing 25.0 μM Ru(bpy)₃²⁺ and 0.1M tripropylamine aqueous solution at a Nano-COT electrode. The potential was stepped from 0.14 V to 1.5 V vs. Ag/AgCl reference electrode for 25 cycles with a 1 second duration per step.

FIG. 13 displays the CV of a Nano-COT electrode in 0.1M PBS buffer (pH=7.5) (A) and NaOH (B) in comparison with bare Pt, ITO and glassy carbon electrodes, showing catalytic oxidation of water to generate hydrogen. Scan rate: 0.005 V/sec.

FIG. 14 displays the water oxidation current density dependence on the temperature used for preparing Nano-COT in hydrogen/methane/nitrogen mix gas.

FIG. 15 displays a photo of water splitting at a Nano-COT electrode anode at 1.5 V (vs. Ag/AgCl) with a graphite electrode as counter electrode.

FIG. 16 displays SEM images of nanostructured Ti electrode prepared by anodization (A) and hydrothermal reaction (C), and corresponding SEM images of NanoCOT electrodes (B) and (D), respectively.

FIG. 17 displays polarization curves in 0.1M NaOH at NanoCOT electrodes obtained at various CVD temperatures.

FIG. 18 displays the water hydrolysis reactivity of a two-electrode system comprised of various cathode and anode materials for optimal hydrogen production.

FIG. 19 displays a scaled up (5″×5″) electrolyzer for water splitting for hydrogen production via a prototype device made of NanoCOT electrode stacks which is powered by solar cell with water supplied via a pump. Bottom image shows a 1.5 cm×1.5 cm electrolyzer fabricated using a NanoCOT electrode stack.

FIG. 20 displays SEM images of nanostructured Ti electrode prepared by hydrothermal reaction (A) and corresponding SEM images of NanoCOT electrodes (B and C) and TEM image of carbon tubes (D).

FIG. 21 displays Raman spectra of a NanoCOT electrode and a thermally annealed bare TiO₂ anodic template.

FIG. 22 displays a XRD spectrum of a NanoCOT electrode at 900° C. in CVD atmosphere.

FIG. 23 displays XPS analysis of the NanoCOT electrode for the (A) Ti 2P, (B) O SS, and (C) C 1S contributions.

FIG. 24 displays CVs of (A) NanoCOT plate, IrOₓ and Pt wires in 1.0M Na₂SO₄ containing 5.0 mM Ru(NH₃)₆Cl₂ in comparison to redox behavior. Scan rate: 100 mV/s. Scan rate dependence of CVs at (B) NanoCOT, (C) IrOₓ and (D) Pt in 1.0M Na₂SO₄ containing 5.0 mM Ru(NH₃)₆Cl₂. Insets of (B, C, D) are the cathodic peak current plotted against the square root of scan rate data and linear fitting results.

FIG. 25 displays the capacitance current density of NanoCOT, Pt and IrOₓ electrodes.

FIG. 26 displays the (A) turn-on potential and (B) anodic current density of NanoCOT, IrOₓ and Pt electrodes in 0.1M KOH solution, at 5 mV/sec.

FIG. 27 displays the proton reduction at the NanoCOT, Pt and NiMoZn/NanoCOT cathodes in 0.1M KOH solution, at 5 mV/sec.

FIG. 28 displays Nyquist plots of the NanoCOT, IrOₓ and Pt at 1.63 V vs. RHE (geometry surface area 0.5 cm²). Inset is the equivalent circuit used to fit the experimental data. Fitting results are shown in Table 2.

FIG. 29 displays (A) Cyclic voltammograms (CVs) of NanoCOT electrode. The electrolyte solution was composed of 0.1M LiClO₄, 10 mM LiI, and 1 mM 12 in acetonitrile. The scan rate was 5 mV/s. Graphite electrode was used as counter electrode and Ag/AgCl works as reference electrode. (B) J-V characteristics of DSSCs with NanoCOT and Pt counter electrode.

FIG. 30 displays (A) SEM images and (B) an XRD spectrum of Powder COT sample.

FIG. 31 displays XPS analysis for the (A) Ti 2P, (B) O 1S, and (C) C 1S contributions for the Powder COT sample. Before data acquisitions, the sample was sputtered with an Ar⁺ ion beam with an incident energy of 3 keV for 30 seconds to clean the surface of the sample.

FIG. 32 displays the OER performance of the Powder COT catalyst in 0.1M 02-saturated KOH from an RDE system (loading catalyst: 0.1 mg/cm² on glassy carbon electrode; rotation speed: 1,600 rom; scan rate: 10 mV/s).

### DETAILED DESCRIPTION

The methods described herein may be understood more readily by reference to the following detailed description of specific aspects of the disclosed subject matter, figures and the examples included therein.

Before the present methods are disclosed and described, it is to be understood that the aspects described below are not intended to be scope by the specific systems, methods, articles, and devices described herein, which are intended as illustrations. Various modifications of the systems, methods, articles, and devices in addition to those shown and described herein are intended to fall within the scope of that described herein. Further, while only certain representative systems and method steps disclosed herein are specifically described, other combinations of the systems and method steps also are intended to fall within the scope of that described herein, even if not specifically recited. Thus, a combination of steps, elements, components, or constituents may be explicitly mentioned herein or less, however, other combinations of steps, elements, components, and constituents are included, even though not explicitly stated.

### General Definitions

The term “comprising” and variations thereof as used herein is used synonymously with the term “including” and variations thereof and are open, non-limiting terms. Although the terms “comprising” and “including” have been used herein to describe various examples, the terms “consisting essentially of” and “consisting of” can be used in place of “comprising” and “including” to provide for more specific examples of the invention and are also disclosed. Other than in the examples, or where otherwise noted, all numbers expressing quantities of ingredients, reaction conditions, and so forth used in the specification and claims are to be understood at the very least, and not as an attempt to limit the application of the doctrine of equivalents to the scope of the claims, to be construed in light of the number of significant digits and ordinary rounding approaches.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

It is understood that throughout this specification the identifiers “first”, “second” and “third” are used solely to aid in distinguishing the various components and steps of the disclosed subject matter. The identifiers “first”, “second” and “third” are not intended to imply any particular order, amount, preference, or importance to the components or steps modified by these terms.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

Reference will now be made in detail to specific aspects of the disclosed materials, compounds, compositions, articles, and methods, examples of which are illustrated in the accompanying examples and figures.

### Nanostructured Electrodes and Catalysts

Disclosed herein are the structural and electrochemical properties of carbon modified nanostructured TiO₂ electrodes (Nano-COT) and catalysts (Powder COT). The Nano-COT electrodes can be prepared, for example, by hydrothermal reaction of Ti in HCl or anodizing titanium in a fluoride-based electrolyte, followed by thermal annealing in atmosphere of methane and hydrogen in the presence of iron precursors. The obtained Nano-COT nanostructured electrodes are highly conductive and contain more than 1×10¹⁰ cm⁻² of nanowires or nanotubes to enhance their double layer charge capacitance and electrochemical stability. An electrogenerated chemiluminescence (ECL) study shows that the Nano-COT electrode can replace noble metal electrodes for ultrasensitive ECL detection. Dynamic potential control experiment of redox reactions showed that the Nano-COT electrode has a broad potential window for a redox reaction. The double layer charging capacitance of the Nano-COT electrode is found to be three orders of magnitude higher than an ideal planar electrode because of its high surface area and efficient charge collection capability due to its nanostructured surface. The effect of anodization voltage, surface treatment with iron precursors for carbon modification, the barrier layer between the Ti substrate and anodized layer on the double layer charging capacitance are studied. Ferrocene carboxylic acid binds covalently to the anodized Ti surface forming a self-assembled monolayer, serving as an excellent precursor layer to yield Nano-COT electrodes with better double layer charging performance than some other precursors. The enhanced oxygen generation efficiency at the Nano-COT electrode is comparable to that of a Pt electrode and much higher than for ITO, glassy carbon and Ti electrodes. Thus the Nano-COT electrodes show promise for replacing expensive platinum electrodes in water splitting applications.

Methods of Making

Disclosed herein are methods for forming carbon-modified nanostructured titanium-based materials. As used herein, “nanostructured” means any structure with one or more nanosized features. A nanosized feature can be any feature with at least one dimension less than 1 m in size. For example, a nanosized feature can comprise a nanowire, nanotube, nanoparticle, nanopore, and the like, or combinations thereof. As such, the nanostructured material can comprise, for example, a nanowire, nanotube, nanoparticle, nanopore, or a combination thereof. In some examples, the nanostructured material can comprise a substrate that is not nanosized by has been modified with a nanowire, nanotube, nanoparticle, nanopore, or a combination thereof.

As used herein, “titanium-based material” means any material comprising titanium. In some examples, the titanium based material can be substantially pure titanium. In some examples, the titanium based material can be a titanium compound. Examples of titanium compounds include titanium oxides (e.g., TiO, TiO₂, Ti₂O₃, Ti₃O₅, Ti₉O₁₇), titanium sulfides (e.g., TiS₂), titanium nitrides (e.g., TiN), titanium carbides (e.g., TiC), titanium halides (e.g., TiCl₄, TiCl₃, TiCl₂, TiBr₄, TiBr₃, TiI₄, TiF₄, TiF₃), titanium nitrates (e.g., Ti(NO₃)₄), titanium phosphides (e.g., TiP), titanium hydrides (e.g., TiH₄, TiH₂), titanium sulfides (e.g., TiS₂, TiS), titanium silicides (e.g., TiSi₂), titanium selenides (e.g., TiSe₂), titanium borides (e.g., TiB₂), titanium alkoxides (e.g., titanium ethoxide, titanium isopropoxide), titanium phosphates, titanium acids, and combinations thereof.

The methods for forming the carbon-modified nanostructured titanium-based material can comprise, for example, contacting an iron impregnated nanostructured titanium substrate with a working gas at a working temperature.

In some embodiments, the method can further comprise contacting a nanostructured titanium substrate with an iron catalyst precursor to form the iron impregnated nanostructured titanium substrate.

The nanostructured titanium substrate can comprise a plurality of nanostructures, such as, for example, nanowires, nanotubes, nanochannels, nanopores, or a combination thereof. In some examples, the nanostructured titanium substrate comprises a plurality of nanowires, nanotubes, or combinations thereof on a titanium substrate. In some embodiments, the nanostructured titanium substrate comprises a plurality of nanopores in a titanium substrate. In some embodiments, the nanostructured titanium substrate can comprise nanoparticles comprising titanium, for example TiO₂ nanoparticles (e.g., particles of TiO₂ with an average largest dimension of 2 μm or less). In some embodiments, the nanostructured titanium substrate can comprise TiO₂ nanoparticle, such as those available from Degussa (P-25). The TiO₂ can comprise an anatase phase and/or a rutile phase. In some examples, polymers can be used to prevent agglomeration and/or aggregation of the nanoparticles.

In some examples, the iron catalyst precursor can comprise Fe(NO₃)₃, ferrocene carboxylic acid, or combinations thereof. In some examples, the iron catalyst precursor can comprise Fe(NO₃)₃.

The working gas can comprise, for example, a hydrocarbon gas. In some examples, the working gas can comprise xylene, ethylene, acetylene, ethane, methane, benzene, toluene, or combinations thereof. In some examples, the working gas comprises methane. In some examples, the working gas can comprise hydrogen gas, for example hydrogen gas in a carrier gas such as nitrogen or argon.

The working gas can, for example, be flowed at a rate of at least 10 sccm (e.g., at least 20 sccm, at least 30 sccm, at least 40 sccm, at least 50 sccm, at least 60 sccm, at least 70 sccm, at least 80 sccm, at least 90 sccm, at least 100 sccm, at least 110 sccm, at least 120 sccm, at least 130 sccm, at least 140 sccm, at least 150 sccm, at least 160 sccm, at least 170 sccm, at least 180 sccm, or at least 190 sccm). In some examples, the working gas can be flowed at a rate of 200 sccm or less (e.g., 190 sccm or less, 180 sccm or less, 170 sccm or less, 160 sccm or less, 150 sccm or less, 140 sccm or less, 130 sccm or less, 120 sccm or less, 110 sccm or less, 100 sccm or less, 90 sccm or less, 80 sccm or less, 70 sccm or less, 60 sccm or less, 50 sccm or less, 40 sccm or less, 30 sccm or less, or 20 sccm or less). In some examples, the working gas can be flowed at a rate of 10-200 sccm (e.g., 20-190 sccm, 30-150 sccm, 40-110 sccm, or 50-70 sccm). In some examples, the working gas can be flowed at a rate of 60 sccm.

The working temperature can be any temperature sufficient to decompose the working gas. In some examples, the working temperature can be at least 800° C. (e.g., at least 825° C., at least 850° C., at least 875° C., at least 900° C., at least 925° C., at least 950° C., or at least 975° C.). In some examples, the working temperature can be 1000° C. or less (e.g., 975° C. or less, 950° C. or less, 925° C. or less, 900° C. or less, 875° C. or less, 850° C. or less, or 825° C. or less). In some examples, the working temperature can be 800-1000° C. (e.g., 825-975° C., 850-950° C., or 875-925° C.).

In some examples, the method can further comprise thermally annealing a nanostructured titanium substrate and contacting the nanostructured titanium substrate with an iron catalyst precursor to form the iron impregnated nanostructured titanium substrate. Thermally annealing the nanostructured titanium substrate can comprise contacting the nanostructured titanium substrate with an annealing gas at an annealing temperature.

In some examples, the method can further comprise thermally annealing the iron impregnated nanostructured titanium substrate. Thermally annealing the iron impregnated nanostructured titanium substrate comprises contacting the iron impregnated nanostructured titanium substrate with an annealing gas at an annealing temperature.

The annealing gas can be, for example, air. The annealing temperature can be any temperature sufficient to improve the properties of the nanostructured titanium substrate, for example, 450° C. In some examples, the nanostructured titanium substrate is contacted with the annealing gas for 1 hour or more (e.g., 2 hours or more, 3 hours or more, 4 hours or more, 5 hours or more, 6 hours or more, 7 hours or more, 8 hours or more, 9 hours or more, or 10 hours or more). In some examples, the thermal annealing can help form an oxide layer. In some examples, the thermal annealing can remove polymers from the titanium nanoparticles.

Also disclosed herein are methods for forming nanostructured electrodes. In some embodiments, the method comprises thermally annealing a nanostructured titanium substrate. The thermal annealing can, for example, help form a titanium oxide layer on the nanostructured titanium substrate.

The nanostructured titanium substrate can comprise a plurality of nanostructures, such as, for example, nanowires, nanotubes, nanochannels, nanopores, or a combination thereof. In some embodiments, the nanostructured titanium substrate can comprise nanoparticles comprising titanium, for example TiO₂ nanoparticles (e.g., particles of TiO₂ with an average largest dimension of 2 μm or less).

In some embodiments, the method further comprises contacting a titanium substrate with an acid at a second elevated temperature (e.g., an acid-contact temperature) to form a nanostructured titanium substrate. The titanium substrate can be substantially pure titanium, for example, 99.0% Ti, 99.1% Ti, 99.2% Ti, 99.3% Ti, 99.4% Ti, 99.5% Ti, 99.6% Ti, 99.7% Ti, 99.8% Ti, or 99.9% Ti.

The acid can comprise any suitable acid, for example, any strong acid, e.g., any acid with a small pKa value. Examples include, but are not limited to, HI, HBr, HClO₄, HCl, H₂SO₄, HNO₃, HClO₃, HBrO₃, HBrO₄, HIO₃, HIO₄, or combinations thereof.

In some examples, the acid comprises an aqueous solution of HCl. The aqueous solution of HCl can, for example, comprise at least 2% by weight of HCl (e.g., at least 2.1% HCl, at least 2.2% HCl, at least 2.3% HCl, at least 2.4% HCl, at least 2.5% HCl, at least 2.6% HCl, at least 2.7% HCl, at least 2.8% HCl, or at least 2.9% HCl). The aqueous solution of HCl can, for example, comprise 3% by weight HCl or less (e.g., 2.9% HCl or less, 2.8% HCl or less, 2.7% HCl or less, 2.6% HCl or less, 2.5% HCl or less, 2.4% HCl or less, 2.3% HCl or less, 2.2% HCl or less, or 2.1% HCl or less). In some examples, the aqueous solution of HCl comprises 2-3% HCl by weight (e.g., 2.1-2.9% HCl, 2.2-2.8% HCl, 2.3-2.7% HCl, or 2.4-2.6% HCl). In some examples, the aqueous solution of HCl comprises 2.5% HCl by weight.

In some examples, the titanium substrate is contacted with the acid for at least 6 hours (e.g., at least 9 hours, at least 12 hours, at least 15 hours, at least 18 hours, at least 21 hours, or at least 24 hours). In some examples, the titanium substrate is contacted with the acid for 30 hours or less (e.g., 24 hours or less, 21 hours or less, 18 hours or less, 15 hours or less, 12 hours or less, or 9 hours or less). In some examples, the titanium substrate is contacted with the acid for 6-30 hours (e.g., 9-24 hours, 12-21 hours, or 15-18 hours). In some examples, the titanium substrate is contacted with the acid for 12 hours.

In some examples, the acid-contact temperature is 190° C.

In some examples, the nanostructured titanium substrate comprises a plurality of nanowires, nanotubes, or combinations thereof on the titanium substrate. The nanowires, nanotubes, or combinations thereof can be, for example, at least 50 nm in diameter (e.g., at least 60 nm, at least 70 nm, at least 80 nm, or at least 90 nm in diameter). The nanowires, nanotubes, or combinations thereof can be, for example, 100 nm or less in diameter (e.g., 90 nm or less, 80 nm or less, 70 nm or less, or 60 nm or less in diameter). The nanowires, nanotubes, or combinations thereof can be, for example, at least 50-100 nm in diameter (e.g., 55-95 nm, 60-90 nm, 65-85 nm, or 70-80 nm).

The length of the nanowires, nanotubes, or combinations thereof can, for example, range from a tens of nanometers to a few microns. For example, the nanowires, nanotubes, or combinations thereof can be at least 10 nm in length (e.g., at least 50 nm, at least 100 nm, at least 200 nm, at least 300 nm, at least 400 nm in length, at least 500 nm in length, at least 1 μm in length, at least 2 μm in length, at least 3 μm in length or at least 5 μm in length). The nanowires, nanotubes, or combinations thereof can be, for example, 10 μm in length or less (e.g., 5 μm or less, 1 μm or less, 500 nm or less, 400 nm or less, 300 nm or less, 200 nm or less, 100 nm or less, or 50 nm or less in length). The nanowires, nanotubes, or combinations thereof can be, for example, 50-500 nm in length (e.g., 100-450 nm, 150-400 nm, 200-350 nm, or 250-300 nm in length).

In some embodiments, the method further comprises contacting a titanium substrate with an anodization solution and applying a potential to the titanium substrate to form a nanostructured titanium substrate. The titanium substrate can be substantially pure titanium, for example, 99.0% Ti, 99.1% Ti, 99.2% Ti, 99.3% Ti, 99.4% Ti, 99.5% Ti, 99.6% Ti, 99.7% Ti, 99.8% Ti, or 99.9% Ti.

In some examples, the anodization solution comprises fluoride ions, such as from ammonium fluoride, HF, or combinations thereof. In some examples, the anodization solution further comprises ethylene glycol.

The potential can be any potential sufficient to form a nanostructured titanium substrate. For example, the potential can be at least 20 V (e.g., at least 35 V, at least 40 V, at least 45 V, at least 50 V, or at least 55 V). In some examples, the potential can be 60 V or less (e.g., 55 V or less, 50 V or less, 45 V or less, 40 V or less, 35 V or less, 30 V or less, or 25 V or less). In some examples, the potential can be 20-60 V (e.g., 25-55 V, 30-50 V, or 35-45 V). In some examples, the potential can be 40 V.

The potential can be applied for any amount of time sufficient to give the desired nanostructured titanium substrate (e.g., to control the pore sizes). In some embodiments, the potential can be applied for at least 1 minute (e.g., at least 30 minutes, at least 1 hour, at least 1.5 hours, at least 2 hours, at least 2.5 hours, at least 3 hours, at least 3.5 hours, at least 4 hours, at least 4.5 hours, or at least 5 hours). In some embodiments, the potential can be applies for 10 hours or less (e.g., 5 hours or less, 4 hours or less, 3 hours or less, 2 hours or less, or 1 hour or less). In some embodiments, the potential can be applies for 1 minute to 10 hours (e.g., 0.5-9.5 hours, 1-9 hours, 1.5-8.5 hours, 2-8 hours, 2.5-7.5 hours, 3-7 hours, 3.5-6.5 hours, 4-6 hours, or 4.5-5.5 hours). In some examples, the potential can be applied for 1 hour.

In some embodiments, the nanostructured titanium substrate comprises a plurality of nanopores in the titanium substrate. The nanopores can be, for example, at least 10 nm in diameter (e.g., at least 20 nm, at least 60 nm, at least 100 nm, at least 140 nm, at least 180 nm, at least 220 nm, at least 260 nm, at least 300 nm, at least 340 nm, at least 380 nm, at least 420 nm, or at least 460 nm). In some examples, the nanopores can be 500 nm or less in diameter (e.g., 400 nm or less, 300 nm or less, 200 nm or less, or 100 nm or less). In some embodiments, the nanopores can be 10-500 nm in diameter (e.g., 20-400 nm, 40-300 nm, 50-200 nm, or 60-100 nm). In some examples, the nanopores can be 60 nm in diameter.

In some examples, the thermal annealing of the nanostructured titanium substrate comprises contacting the nanostructured titanium substrate with an annealing gas at a third elevated temperature (e.g., an annealing temperature).

The annealing gas can be, for example, air. The annealing temperature can be any temperature sufficient to improve the properties of the nanostructured titanium substrate, for example, 450° C. In some examples, the nanostructured titanium substrate is contacted with the annealing gas for 10 hours.

In some embodiments, the method further comprises contacting the nanostructured titanium substrate with an iron catalyst precursor to create an iron impregnated nanostructured titanium substrate.

In some examples, the iron catalyst precursor comprises Fe(NO₃)₃, ferrocene carboxylic acid, or combinations thereof. In some examples, the iron catalyst precursor comprises Fe(NO₃)₃. In some examples, the Fe(NO₃)₃ is contacted with the nanostructured titanium substrate in the presence of UV light.

In some embodiments, the method further comprises contacting the iron impregnated nanostructured titanium substrate with a working gas at a first elevated temperature (e.g., a working temperature).

In some examples, contacting the impregnated nanostructured titanium substrate with a working gas at a working temperature comprises a form of chemical vapor deposition (CVD). A variety of chemical vapor apparatus can be used. A chemical vapor deposition apparatus typically comprises a horizontal tubular reactor equipped with a susceptor for mounting a substrate thereon, a heater for heating the substrate, a feed gas introduction portion arranged such that the direction of the feed gas fed in a tubular reactor is made parallel to the substrate, and a reaction gas exhaust portion. Thus the substrate is placed on the susceptor in the tubular reactor, the substrate is heated, and a gas containing a feed gas is supplied in the reactor in the direction parallel to the substrate so that a chemical vapor deposition forms a film on the substrate. See U.S. Pat. No. 6,926,920, U.S. Publication No. 2002-0160112, which are incorporated by reference herein for their teachings of CVD techniques. In some examples, the feed gas is a carbon precursor, for example, xylene, toluene, benzene, methane, ethane, and the like. A carrier gas, such as a mixture of hydrogen and argon, can also be used.

The working gas can comprise, for example, a hydrocarbon gas. In some examples, the working gas can comprise xylene, ethylene, acetylene, ethane, methane, benzene, toluene, or combinations thereof. In some examples, the working gas comprises methane.

The working temperature can be any temperature sufficient to decompose the working gas. In some examples, the working temperature can be at least 800° C. (e.g., at least 825° C., at least 850° C., at least 875° C., at least 900° C., at least 925° C., at least 950° C., or at least 975° C.). In some examples, the working temperature can be 1000° C. or less (e.g., 975° C. or less, 950° C. or less, 925° C. or less, 900° C. or less, 875° C. or less, 850° C. or less, or 825° C. or less). In some examples, the working temperature can be 800-1000° C. (e.g., 825-975° C., 850-950° C., or 875-925° C.).

The working gas can, for example, be flowed at a rate of at least 10 sccm (e.g., at least 20 sccm, at least 30 sccm, at least 40 sccm, at least 50 sccm, at least 60 sccm, at least 70 sccm, at least 80 sccm, at least 90 sccm, at least 100 sccm, at least 110 sccm, at least 120 sccm, at least 130 sccm, at least 140 sccm, at least 150 sccm, at least 160 sccm, at least 170 sccm, at least 180 sccm, or at least 190 sccm). In some examples, the working gas can be flowed at a rate of 200 sccm or less (e.g., 190 sccm or less, 180 sccm or less, 170 sccm or less, 160 sccm or less, 150 sccm or less, 140 sccm or less, 130 sccm or less, 120 sccm or less, 110 sccm or less, 100 sccm or less, 90 sccm or less, 80 sccm or less, 70 sccm or less, 60 sccm or less, 50 sccm or less, 40 sccm or less, 30 sccm or less, or 20 sccm or less). In some examples, the working gas can be flowed at a rate of 10-200 sccm (e.g., 20-190 sccm, 30-150 sccm, 40-110 sccm, or 50-70 sccm). In some examples, the working gas can be flowed at a rate of 60 sccm.

In some embodiments, the nanostructured electrode comprises titanium, carbon and oxygen. For example, the ratio of Ti:C:O can be 1:0.32:0.46. In some examples, the nanostructured electrode comprises at least 3 atomic % carbon. In some examples, the nanostructured electrode has a decreased oxygen content compared to TiO₂.

The nanostructured electrode can comprise a plurality of nanostructures, such as, for example, nanowires, nanotubes, nanochannels, or a combination thereof. In some examples, the density of nanostructures on the nanostructured electrode is 1×10¹⁰ cm².

In some examples, the properties of the nanostructured electrode are improved compared to those of a bare gold electrode. For example, the double layer charging capacitance of the nanostructured electrode can be increased at least 5 times compared to that of a bare gold electrode.

In some examples, the double layer charging capacitance of the nanostructured electrode is 4800 μC/cm².

In some examples, the nanostructured electrode has a 48-480 fold increase in charge density compared to an ideal planar electrode. In some examples, the nanostructured electrode has a 48-480 fold increase in surface area compared to an ideal planar electrode.

In some examples, the peak current of the nanostructured electrode increases linearly with the square root of scan rate. In some examples, the nanostructured electrode exhibits reversible redox characteristics. In some examples, the nanostructured electrode exhibits linear mass transfer features.

In some examples the specific capacitance of the nanostructured electrode is at least 5 F/g (e.g., at least 5.5 F/g, at least 6 F/g, at least 6.5 F/g, at least 7 F/g, at least 7.5 F/g, at least 8 F/g, at least 8.5 F/g, at least 9 F/g, at least 9.5 F/g, at least 10 F/g, at least 10.5 F/g, at least 11 F/g, or at least 11.5 F/g). In some examples, the specific capacitance of the nanostructured electrode can be 11.9 F/g.

In some embodiments, the operating voltage of the nanostructured electrode can be 1.2 V or less (e.g., 1.1 V or less, 1.0 V or less, 0.9 V or less, 0.8 V or less, 0.7 V or less, 0.6 V or less, 0.5 V or less, 0.4 V or less, 0.3 V or less, 0.2 V or less, or 0.1 V or less).

In some embodiments, the nanostructured electrode exhibits enhance current density for water oxidation compared to indium tin oxide (ITO) electrodes or glassy carbon electrodes. In some examples, the current density of the nanostructured electrode is at least 30% higher than that of a planar Pt electrode. In some examples, the current density of the nanostructured electrode is at least 4 times that of a glassy carbon electrode. In some examples, the current density of the nanostructured electrode is at least 20 times that of an ITO electrode.

Also disclosed herein are methods for forming nanostructured catalysts. The methods can comprise, for example, contacting a nanostructured titanium substrate with an iron catalyst precursor to create an iron impregnated nanostructured titanium substrate.

The nanostructured titanium substrate can comprise, for example, a plurality of nanoparticles comprising titanium, for example TiO₂ nanoparticles (e.g., particles of TiO₂ with an average largest dimension of 2 μm or less).

In some embodiments, the method can further comprise thermally annealing the iron impregnated nanostructured titanium substrate. In some embodiments, the method can further comprise contacting the iron impregnated nanostructured titanium substrate with a working gas at a working temperature, thereby creating the nanostructured catalyst.

Thermally annealing the iron impregnated nanostructured titanium substrate can, for example, comprise contacting the iron impregnated nanostructured titanium substrate with an annealing gas at an annealing temperature.

In some examples, the nanostructured catalyst can comprise titanium, carbon and oxygen. The ratio of Ti:C:O can, for example, be 1:0.3:1.9.

The nanostructured catalysts can, in some example, be used as an electrode (e.g., a nanostructured electrode). In some example, a glassy carbon electrode can be loaded with the nanostructured catalyst, for example to make a nanostructured electrode.

The electrode comprising the nanostructure catalyst (e.g., the nanostructured electrode) can, for example, be used in a water splitting reaction, in a solar cell, in a charge storage device, or a combination thereof.

Methods of Use

Nanostructured electrodes containing nanowires, nanoparticles and other features in the nanometer domain are of great interest for many applications, as well as for the fundamental understanding of structural dependence of redox reaction activities at small sized electrodes.

Firstly, the mass transfer dynamics of redox species at the nanometer sized electrode surface differ greatly to that of a bulk planar electrode. This is because the thickness of the redox diffusion layer at a nanostructured electrode is comparable to the dimensions of the nanostructured electrode. This thin diffusion layer produces a concentration profile of redox species that is independent of the scan rate of the electrode potential, if the diffusion layers of each individual nanoelectrode domain do not overlap with each other. Meanwhile, unstable intermediates produced at a working electrode can be electrochemically detected at fast potential scan rates. The contribution from double layer charging to the overall collected current is small due to the fast mass transfer of the redox reaction and small surface area of a single nanoelectrode. When diffusion layers of individual nanoelectrodes overlap with each other due to their close proximity, the collective response of the redox concentration profile will depend on the real surface area of the nanostructured electrode, as well as other parameters such as size distribution and relative distance of the nanosized domains on the nanostructured electrode surface. Secondly, when the electrode size is comparable to the size of a redox center (e.g., at the nanometer size scale), the electrodes can serve as nanosized antenna to facilitate redox charge transfer.

Because of these interesting electrochemical properties of nanostructured electrodes, they can be utilized in many applications. For example, nanoelectrodes are used as electrode materials for lithium batteries, double layer charge storage capacitors, elements for signal transduction of a sensor for detecting specific molecular recognition electrochemically, photoactive materials of photovoltaic devices, and electrode materials to enhance ECL. In the charge storage area, increased real surface area versus geometric area is an important factor that determines the double layer capacitance of a nanostructured electrode. Reliable electrical contact to each individual nanostructure on the charge collector substrate is also critical to address the charge storage and collection effectively. Nanostructured electrodes such as nanotubes and nanowires have been used to enhance double layer charge storage performance. The function of the nanostructured electrode with nanowire structures is twofold: first, they can enhance the surface area of the charge storage electrode, and, second, they serve as reliable electrical contacts to the charge collector and as a scaffold for the attachment of redox active species (e.g., metal oxides) in the application of electrochemical energy storage systems. Such modification with nanostructured electrodes has shown remarkable contribution to charge storage properties because of the extremely high surface-to-volume ratios and the short ion diffusion path length. For example, Li and co-workers recently demonstrated the coating of carbon microfibers with ultra-thin films of MnO₂ and Zn₂SnO₄ for use as high performance supercapacitor electrodes (Bao, L; Zang, J; Li, X. Nano Lett. 2011, 11, 1215-1220). Dong and coworkers demonstrated that MnO₂ coated titanium nitrite nanotube array displayed high performance charge storage (Dong et al. Energy Environ. Sci. 2011, 4, 3502-3508). More recently, functionalized nanostructured TiO₂ electrodes have been used for electrochemical applications due to their high chemical stability, excellent functionality, nontoxicity, and relatively low price. Hu and coworkers used carbon doped TiO₂ porous templates to achieve excellent electrochemical catalytic performance of such electrodes for biomolecular sensing (Hu et al. Anal. Chem. 2011, 83, 8138-8144). Such carbon doping was obtained using a self-doping method that simply anneals as-anodized TiO₂ film in argon without using other carbon precursors. Other carbon doping methods, such as annealing TiO₂ under carbon monoxide, have been used to obtain conductive and catalytic TiO₂ electrodes for sensing. Schmuki and co-workers used acetylene as a carbon source to dope an anodized TiO₂ template to obtain semimetallic TiO₂ nanotubes for electrochemical catalytic reaction (Hahn et al. Angew. Chem., Int. Ed. 2009, 48, 7236-7239).

Herein, the structural and electrochemical characteristics of carbon modified anodized TiO₂ electrodes, prepared by thermal annealing of an anodized TiO₂ template in an atmosphere of methane and hydrogen in presence of an iron precursor, are disclosed. Highly conductive nanostructured electrodes with high surface areas are studied. The enhanced double layer charging performance and redox reactions (e.g., water oxidation) at the new carbon modified electrodes are addressed quantitatively using digital simulation. The structure and double layer capacitance of the carbon modified electrodes are studied using various surface characterization tools and electrochemical methods (e.g., cyclic voltammetry and ECL) to learn the effect of carbon modification conditions on their double layer charge storage performance and redox reaction stability.

Also disclosed herein are methods of use of the nanostructured electrodes described herein as an electrode in a water splitting reaction. Also disclosed herein are methods of use of the nanostructured electrodes described herein as an electrode in a solar cell. Also disclosed herein are methods of use of the nanostructured electrodes described herein as an electrode in a charge storage device.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

### Methods

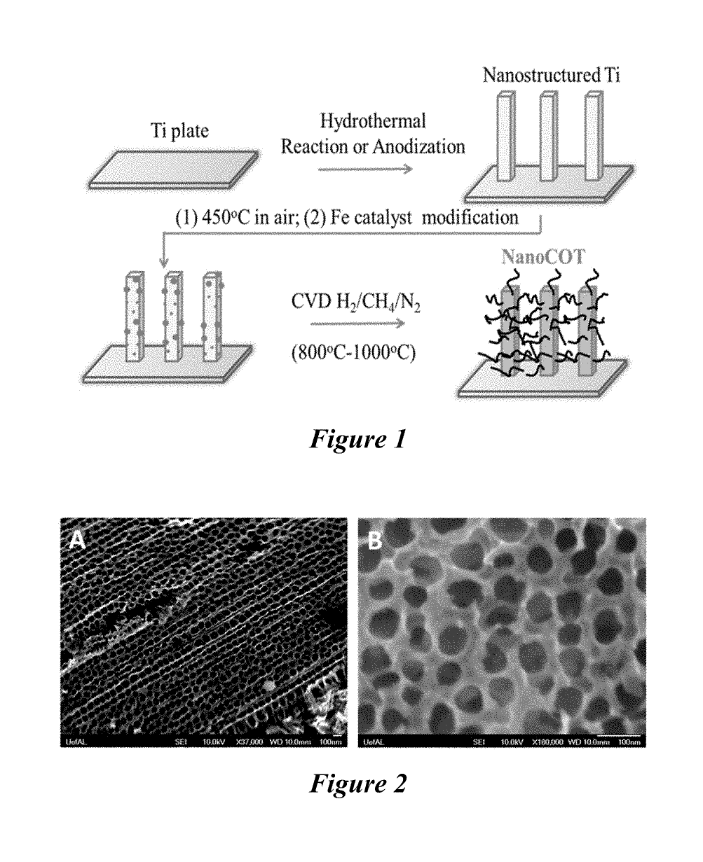

As shown in FIG. 1, a Ti substrate can be nanostructured via either anodization or hydrothermal reaction, followed by carbon transformation using a CVD system in order to obtain optimal composition and functionality of the Nano-COT electrode.

### Anodization of Ti

Ordered TiO₂ nanotube templates were made by one-step anodic oxidation of 99% or 99.6% pure titanium substrates (Alfa Aesar). The electrochemical cell employed consisted of a double copper cathode on which the Ti substrates were attached with conductive tape. The Ti substrate was immersed in ethylene glycol containing 2% (w/w) H₂O and 0.3% (w/w) NH₄F. The solution was stirred constantly throughout the entire anodization process. The anodization voltage was supplied by a variable voltage DC source (Agilent Technologies N57550A) while the current density was recorded using a multimeter (Extech Instruments Multiview 110) connected in series. Typically, a 5 mm×1 cm Ti plate was anodized at a voltage of 40 V and current of around 1 A for 1 hour.

### Removing TiO₂ Barrier Layer

Removal of the TiO₂ barrier layer was achieved using a Keithley 2400 multimeter controlled using Labview software, which allowed incremental decreases in the voltage from the initial anodization voltage. This barrier removal step used the same cell setup as in the previous anodization step. The program was set to decrease the voltage by 5% of its magnitude every 25 seconds starting from the anodization voltage to 0.1 V. Upon completion of the voltage step process, the TiO₂ substrates were removed and washed with distilled water and acetone before being dried with compressed air to remove all traces of the electrolyte solution. After anodization and barrier removal, a small amount of high purity silver paste was applied to one side of the exposed Ti in order to maintain good electrical connection post annealing. The substrates were then annealed for in a muffle furnace (Thermo Scientific) at 450° C. for an hour in air.

### Loading of Fe Precursor to Anodized TiO₂ Template for Carbon Modification

Iron (Fe) is able to break down methane molecules into hydrogen and carbon. Therefore, various Fe loading techniques were studied in an attempt to enhance the Fe coverage of the TiO₂ substrate, improve carbon modification efficiency, and study the effects of carbon modification on the electrochemical performance of the anodized TiO₂ electrodes. After annealing at 450° C. for 1 hour, the substrates were subjected to various different Fe solutions: 1) 1M Fe(NO₃)₃ for 20 minutes before washing with DI water, acetone and air drying; 2) 10 mM ferrocene carboxylic acid solution in ethanol for 4 hours before washing with DI water, acetone and air drying; or 3) submersed in 1M Fe(NO₃)₃ under UV light for 30 minutes on each side before washing with DI water, acetone and air drying. The mass of the dried substrates was recorded prior to the next carbon modification step.

### Carbon Modification of Anodized TiO₂ Template to Form Nano-COT Nanostructured Electrode

To transform the anodized TiO₂ template into a useful electrode material, all Fe precursor treated TiO₂ substrates were loaded into a tube furnace (X1100 MTIXTL) and thermally annealed in the presence of a gas mixture of 16% CH₄, 20.51% H₂ and balance N2. In order to load the substrates into the tube furnace for carbon modification, the substrates were placed into a quartz boat horizontally so that both the top and bottom of the substrates were exposed to air before being covered by quartz plates above. N2 gas was passed through the furnace for ˜20 minutes to purge any 02 within the chamber before several vacuum/N2 purge cycles were carried out. The furnace was set to heat up to a temperature of 1000° C. with a ramp rate of 50° C./min and a dwell time of 1 hour. When the furnace reached a temperature of approximately 700-750° C. the N2 gas was turned off and the CH₄/H₂/N₂ gas mixture was turned on at a flow rate of around 60 sccm. After the heating cycle had concluded the furnace was left to cool to room temperature. When the furnace cooled to a temperature of approximately 700-750° C. the CH₄/H₂/N₂ gas flow was turned off and the nitrogen flow was restarted and remained on until the substrates had reached room temperature.

### Electrochemical and Structural Characterizations

The electrochemical properties of the Nano-COT electrodes were first characterized in 1.0M Na₂SO₄ containing 5.0 mM K₃Ru(NH₃)₆ or 5.0 mM K₃Fe(CN)₆. The Ti substrates utilized in the above procedure for the fabrication of Nano-COT electrodes were studied by cyclic voltammetry (CV) at each stage of the fabrication process in 0.1M NaOH using a potentiostat (CHI1207a, CHI Instruments). An electrochemical cell was set up with the Nano-COT electrode as the working electrode, a platinum wire counter electrode, and a Ag/AgCl reference electrode with 3.5M KCl. Electrogenerated chemiluminescence (ECL) was obtained using a custom ECL setup, described fully elsewhere (Benoist, D; Pan, S L. J Phy. Chem. C 2010, 114, 1815-182124; Hill, C; Zhu, Y; Pan, S L. ACS Nano 2011, 5, 942-951). The microscopic morphology of the obtained nanoelectrodes was confirmed using scanning electron microscopy (SEM) (JEOL 7000 FE SEM). Transmission electron microscopy (TEM) samples were prepared by removing the Nano-COT nanostructures from the Ti substrate by scraping with a razor blade and suspending them in DI water prior to being transferred onto a 200 mesh copper grid (Electron Microscopy Sciences, Hatfield, Pa.). The samples were then imaged using a FEI Tecnai F-20 TEM (FEI, Hillsboro, Oreg.). X-Ray diffraction (XRD) measurements were taken using a Brukker D8 XRD (Cobalt X-ray tube, Kul, 1.78896 Å, 40 kV and 35 mA) at room temperature in air.

### Results and Discussion

### Anodization of Ti and Morphology Characterization.

Anodization of a Ti substrate not only produces a nanoporous TiO₂ structure containing nanochannels layered on top of the Ti substrate, which is important for maximizing the surface area of the electrode, but also helps form nanowire and nanotube features of Nano-COT after the Fe catalyzed carbon modification reaction. The mechanism that leads to the formation of nanochannels is believed to begin with water electrolysis at the Ti anode to produce a compact TiO₂ layer. Soluble fluoride ions then start a direct complexation reaction with Ti⁴⁺ at the oxide/electrolyte interface to chemically etch away part of the TiO₂ surface. This chemical complexation reaction begins to compete with the anodic oxidation at the Ti-liquid interface under the applied constant voltage to yield a thick oxide layer containing vertically aligned self-organized nanochannels. The length and pore size of the nanochannels produced in the TiO₂ layer can be precisely controlled via the anodization conditions such as voltage, current density and anodization time. Perfect uniformity of pore size and distribution was not achieved across the entire substrate using the one-step anodization herein. However, highly ordered oxide template can be prepared by ultrasonically removing the first layer of TiO₂ nanotubes in water and further repeating the anodization step under the same anodization condition as the first one, or using pattern-guided anodization. SEM images of the porous TiO₂ template after removing the barrier layer and annealing shows disordered pores because no special surface treatment was applied (FIG. 2). The average pore size of the template anodized at 40 V is about 60 nm in diameter.

### Carbon Modification of TiO₂ Template and Structure Characterization.

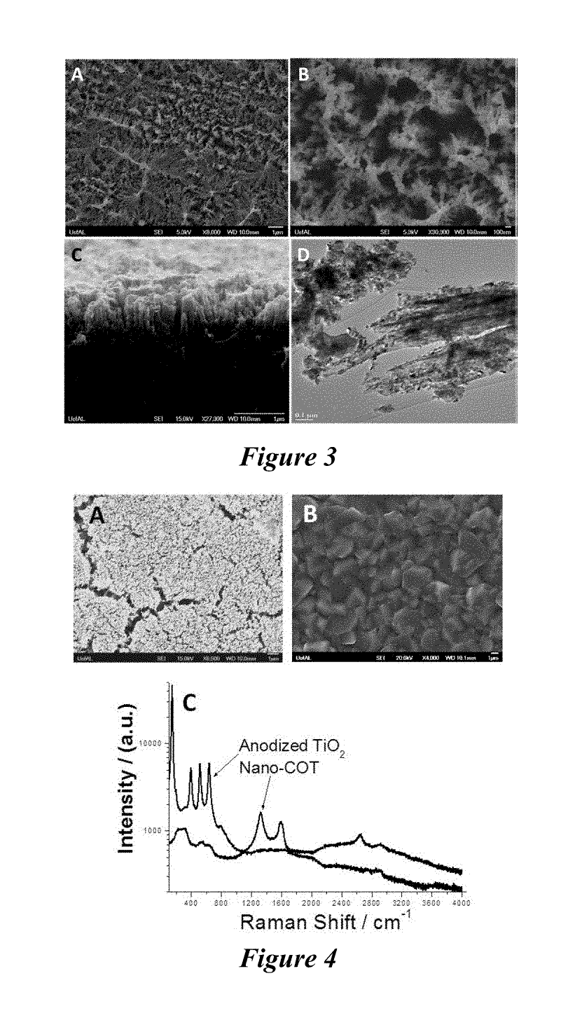

Microscopic structure changes and the electrochemical performance of the anodized TiO₂ nanostructure with and without carbon modification were studied. As shown in FIG. 3, the porous TiO₂ morphology readily changes after anodization to bundles of nanowires of Nano-COT when a high purity Ti substrate is anodized. The morphology change can be explained by the fact that TiO₂ template can melt at 1000° C., while the presence of hydrogen and C from CH₄ can reduce the oxide to form doped TiO₂, which presumably has higher melting temperature and hardness than anatase TiO₂. The physical change of the TiO₂ at high temperatures and the chemical reduction reaction work collectively to yield new nanostructured features that are different from that of the anodized TiO₂. The morphology of the Nano-COT electrode formed from pure Ti shows nanowire structures that form when the boundaries of nanochannels of the anodized TiO₂ template collapse at high temperatures. Element analysis of a selected area of the Nano-COT nanowire coated substrate shows 2.92% (atomic %) C is present in the titanium sample, while having a lower percentage of oxygen than pure TiO₂. The morphology formed after carbon modification is also dependent on the purity of the starting Ti substrate. For instance, the morphology of the carbon modified TiO₂ substrate made from 99% Ti does not show extended nanowire shapes, because the impurities present in the starting material can increase the hardness of the anodized TiO₂ template allowing it to maintain its morphology during the carbon modification process. SEM images of the TiO₂ substrates formed from 99% Ti shows they contain pores with poor periodicity and ordering, meaning the morphology obtained after the carbon modification is less ordered than that of the pure Ti substrate. A cross-sectional view of the C-modified TiO₂ in FIG. 3C shows that the carbon modified TiO₂ template prepared by anodizing the 99.0% Ti substrate has nanotube structures, and element analysis shows that a large fraction of the O is replaced by C. To further examine the morphology of the Nano-COT nanostructured electrodes at the nanometer scale, a small amount of the carbon doped nanowires were transferred onto a TEM grid for high resolution TEM imaging (FIG. 3D). TEM images show tubular nanostructures of the Nano-COT sample as well as small nanoparticles, which might be small graphite nanoparticles and/or catalytic precursors used for methane decomposition. There are no carbon nanotubes formed on the Ti oxide substrates, even in the presence of Fe catalyst.

As stated above, the formation of the interesting Nano-COT nanowires or nanotubes has to do with the morphology change of the TiO₂ at high temperature and its collective response to the chemical reduction reaction. Mechanistic evidence of how the carbon modification process in the presence of methane and hydrogen helps transform the nanochannels of the TiO₂ template into a nanostructured electrode with nanowires and nanotubes was gleaned from a control experiment. The control experiment involved a bare TiO₂ template treated at the same temperature under a nitrogen environment, in the absence of methane and hydrogen, to compare with Nano-COT. As shown in FIG. 4, nanochannels of the anodized TiO₂ template are completely transformed to large crystalline domains of TiO₂ when the nanoporous TiO₂ template melts (FIG. 4B) in comparison to Nano-COT (FIG. 4A). The thermally treated TiO₂ template in the absence of methane and hydrogen show extremely high resistivity. This indicates that the carbon modification in presence of hydrogen and methane helps the TiO₂ template morphology transformation to provide new nanosized features with high surface area. Surface coverage of the nanowires (for high purity Ti) and nanotubes (for low purity Ti) was around 1×10¹⁰ cm⁻², which is close to that of the nanopore density before being transformed to the new nanostructured Nano-COT surface.

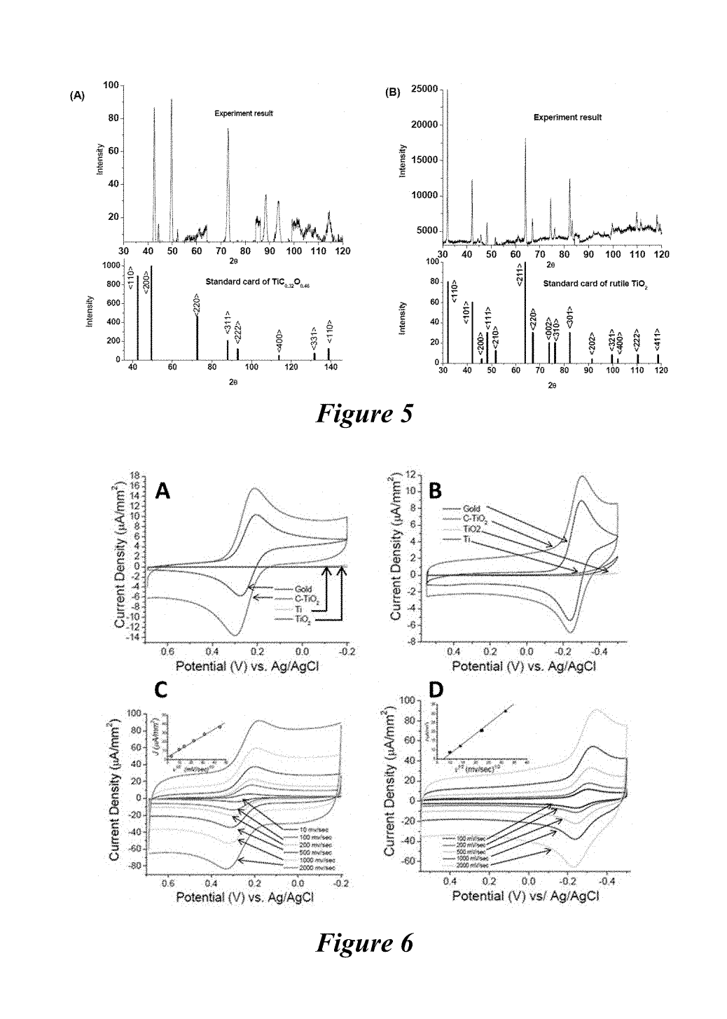

Raman was then used to reveal the structural information of the Nano-COT nanostructures. FIG. 4C shows the comparison of the Raman features of the anodized TiO₂ after annealing at 450° C., with that of Nano-COT. The Raman features of the anodized TiO₂ indicate that the crystalline structure of the oxide is anatase. The features of Ti oxide after C modification is not quite clear in the Raman spectra due to the dramatic changes in its electronic structure and composition. The spectra indicating the anodized TiO₂ has Raman lines at around 150, 400, 500 and 650 cm⁻¹, which correspond to the E_{g}, B_{1g}, A_{1g} or B_{1g} and E_{g} modes of the anatase phase of TiO₂, respectively. After carbon modification, the main Raman lines correspond to the D and G bands of carbon. This implies that there is still trace amounts of carbon deposited onto the Nano-COT substrate during thermal annealing in the presence of methane and hydrogen. XRD of the Nano-COT (FIG. 5) and a calculated standard show that the carbon modified Ti oxide has a composition of TiCo_{0.32}O_{0.46}. The actual composition stoichiometry varies from sample to sample depending on the carbon modification conditions, Fe precursor loading method and anodization conditions of the Ti substrates.

To evaluate the conductivity, surface area change and electrochemical stability of the Nano-COT nanoelectrodes, their performance was first investigated by using dynamic control of electrode potential in the presence of two common reversible redox species and comparing with the redox behavior of a bare gold disc electrode. FIG. 6A shows the comparison of the cyclic voltammogram (CV) of Fe(CN)₆³⁻ at a Nano-COT electrode with that of a bare gold electrode at a potential scan rate of 100 mV/sec. The pronounced reversible redox behavior of Fe(CN)₆³⁻ at the Nano-COT surface is clearly shown. No strong adsorption of Fe(CN)₆³⁻ ions on the surface of the carbon modified electrode is observed due to the large offset of the cathodic and anodic peak potentials, Eₚₐ and E_{pc}, respectively. The difference between E_{pc} and Eₚₐ, ΔE, of the CV is about 65 mV for both the Nano-COT and bare gold disc electrodes. These results indicate that the carbon modified TiO₂ electrode is highly conductive and the redox reaction of Fe(CN)₆³⁻ at its surface is highly reversible. Other control electrodes (a bare Ti electrode and nanostructured TiO₂ on a Ti substrate), with the same electrode size as Nano-COT, showed no redox reaction behavior due to their inert surface and slow charge transfer reaction kinetics. Positively charged redox ions, Ru(NH₃)₆³⁺, were then used to probe the electrochemical activities of the Nano-COT electrodes. As shown in FIG. 6B, a highly reversible CV of Ru(NH₃)₆³⁺ can be obtained at the carbon modified TiO₂ electrodes with a AE around 65 mV, which is close to that of the bare gold disc electrode. Two control experiments, bare Ti and anodized Ti coated with TiO₂, showed no redox reaction for Ru(NH₃)₆³⁺, showing that the reaction of Ru(NH₃)₆³⁺ at bare Ti and TiO₂ electrodes is sluggish. The double layer charging current is much larger at the Nano-COT electrode than the gold electrode. This is due to the high surface area of the nanostructured electrode, as shown in the SEM imaging studies.

To compare the mass transfer behavior of the redox species and the double layer charging effect at the bare gold electrode and Nano-COT, the scan rate dependence of the cathodic peak current is shown in FIGS. 6C and D at the Nano-COT electrode. The peak current of the C-modified TiO₂ electrodes linearly increases with the square root of the scan rate, indicating the reversible reaction characteristics of the redox reaction and linear mass transfer features of redox species at the Nano-COT nanoelectrodes during the range of applied scan rates. It should be noted that the faradaic current density at the Nano-COT electrode is found to be only slightly higher than at the bare gold disc electrode. This can be explained by the fact that the geometric surface area plays a major role at slow scan rates. Slow scan rates produce a thick redox diffusion layer of redox molecules, so that the nanostructured surface has no contribution to the overall mass transfer process. FIGS. 6C and D also show the dramatic increase in double layer charging current density at the Nano-COT nanoelectrode in comparison to the bare gold disc electrode. This can be explained by fast ion diffusion and migration near the nanostructured electrode, which has a much larger surface area than the planar gold electrode, under the applied potential in a strong electrolyte. The nanostructured of the electrode causes much thinner diffusion layers of ions than for the gold planar electrode under high ionic strength conditions, so that the nanostructured electrode can produce much greater double layer charging capacitance than the bare gold electrode. It is also shown that the double layer charge storage capacity of the Nano-COT is not due to Ru(NH₃)₆³⁺ and Fe(CN)₆³⁻ because there is no surface absorption of redox species onto the Nano-COT nanoelectrode to enhance the overall current density. Therefore, the enhanced double layer charging capacitance at Nano-COT is mainly from the response of Na⁺ and SO₄²⁻ ions.

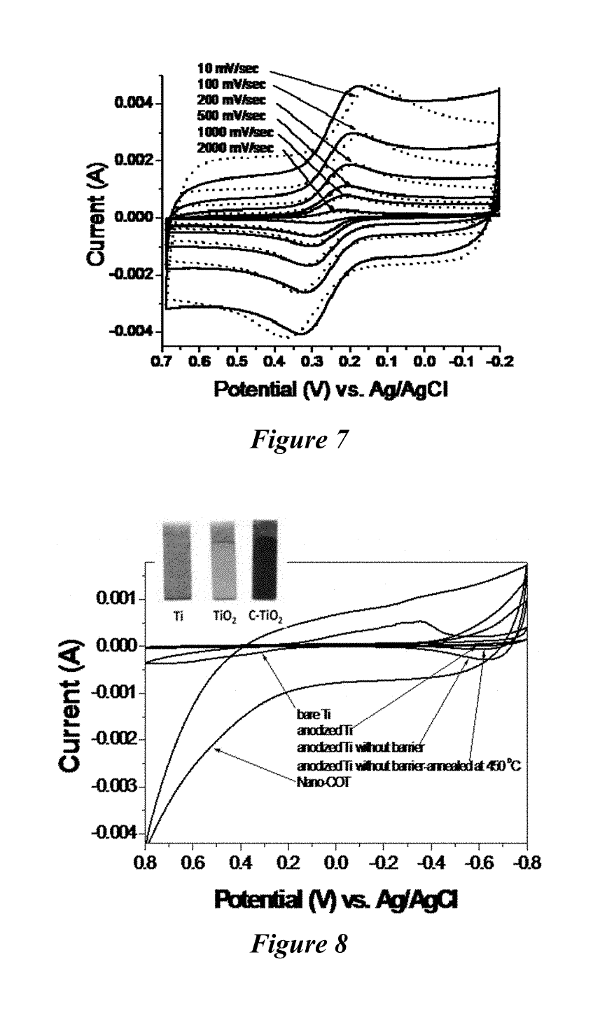

To address the charge storage performance at the Nano-COT quantitatively, digital simulations were used to fit the redox reaction behavior and double layer charging performance at various scan rates. As shown in FIG. 7, the experimental data at low scan rates can be fit using an equivalent circuit model of a semi-infinite one-dimensional planar electrode by including a double charging capacitor, redox reaction and Ohmic drop correction. The double layer charging capacitance was found to be 4800 μC/cm² as calculated from the geometric area of the Nano-COT electrode. This charge density is about 48-480 fold of that of an ideal fully charged planar surface and can be explained by the 48-480 fold increase in real surface area in comparison to a planar electrode. The equivalent model does not work well at high scan rates, as the system was over-simplified by considering the nanostructured electrode as a planar system. This is because thinner diffusion layers can be developed for redox reactions at fast electrode potential scan rates and detailed consideration of the real surface area and local geometries are needed to explain the discrepancy of calculated results and experimental data.

### Effect of Anodization Voltage and Fe Precursor Loading on Double Layer Charging Capacitance of Nano-COT Electrode.

Carbon growth on various substrates is can be catalyzed by Fe under appropriate carbon modification conditions. However, there were no carbon nanotubes present on the surface of the Fe precursor-treated TiO₂ template under the thermal annealing treatment conditions discussed herein in the presence of methane and hydrogen. This has to do with the physical changes in the morphology of the TiO₂ and reduction of the oxide substrate by carbon and hydrogen. Carbon nanotubes supported by TiO₂, TiO₂-carbon nanotube nanocomposites, self-standing carbon nanotubes grown on top of anodized TiO₂ templates, and carbon-doped TiO₂ have been investigated for photocatalytic applications because of the attractive photoelectrochemical activity of TiO₂ upon UV light absorption. However, the conductivity of TiO₂ was not improved through these modifications and few experiments have been carried out to demonstrate the charge storage behavior of such doped electrodes. The results discussed herein show substantial improvement on the conductivity of TiO₂ films after transforming their morphology (e.g., increasing the surface area) by incorporating carbon into the oxide nanoelectrode.

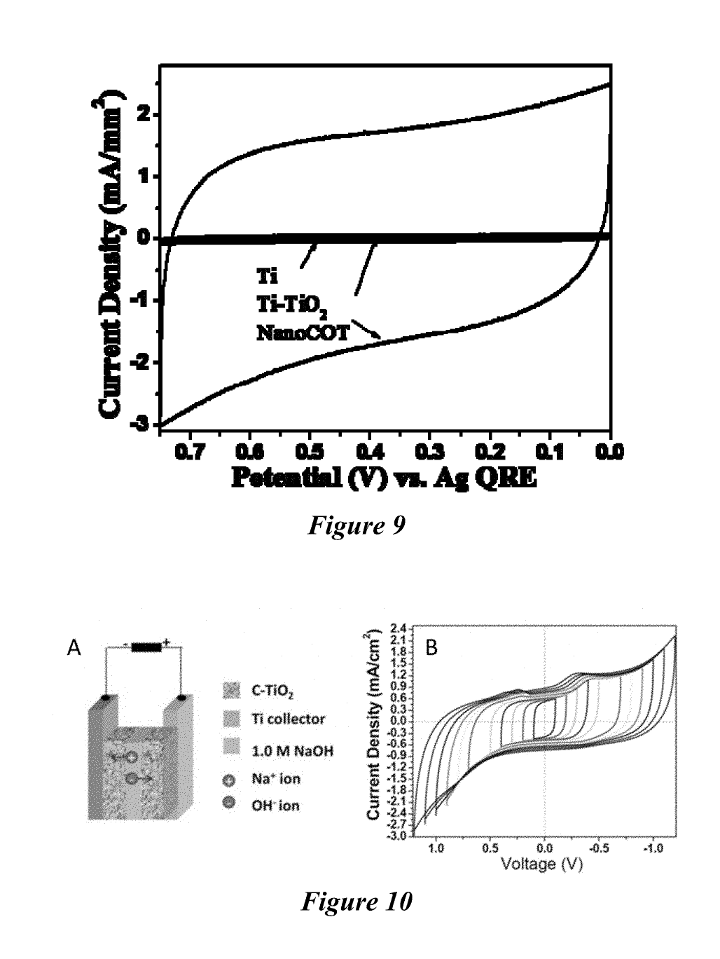

To study the effect of sample preparation procedures on the double layer capacitance and electrode conductivity, CV was used to measure the charging/discharging characteristics of the substrate at each stage of the fabrication process (FIG. 8). The specific capacitance of the TiO₂ electrodes before and after carbon modification was 0.29 and 11.91 F/g, respectively. The pronounced increase in current response of the Nano-COT substrate indicates that carbon modification can dramatically improve the surface area and conductivity. The carbon modification yielded black coated substrates, with vast improvements in their current response and specific capacitance when compared to the same substrates without carbon modification. The current response was measured using CV at incremental scan rates. The steady state current can be given by i=vC_{d} where v is the potential sweep rate in V/s. Under ideal conditions, a symmetric graph above and below the zero current would be obtained, indicating perfect charging and discharging cycles. The current would increase and reach a steady state at which the double layer capacitance (C_{d}) could be calculated for a given scan rate. CVs obtained for the Nano-COT substrates did not display this ideal behavior, as they were asymmetric above and below zero current. The presence of a cathodic current peak in the obtained graphs indicates that there was some influence from redox reactions, notably the oxidation of carbon. The cathodic and anodic current at the zero potential at each scan rate are plotted against the scan rate to give a linear graph with slope C_{d} for the charging and discharging cycles. The specific capacitance for each charging and discharging cycle was determined and the mean taken as an estimation of the specific capacitance. The mass of each Nano-COT electrode was measured before and after carbon modification. This gave an approximation of the mass of active material, which permitted calculation of the specific capacitance per gram of active material. This method, however, assumed that all the mass gained during carbon modification was from the doped carbon. Given that the actual surface of the electrode that was used for the electrochemical test is smaller than the anodized portion of the electrode, the mass of active material is being overestimated, which in turn leads to an underestimation of the specific capacitance. The average specific capacitance of the carbon modified TiO₂ electrode is as high as 11.91 F/g in 0.1M NaOH. This is a large improvement over the 0.29 F/g calculated for the annealed TiO₂ substrate before carbon modification. Equivalent charge storage performance and improved electrode stability can be obtained in organic solvents in comparison with aqueous electrolytes (FIG. 9).

Further experiments were carried out in order to determine the effect of anodization voltage on the double layer charging capacitance of Nano-COT. Nano-COT prepared from anodized template at 60 V was found to have a far larger current response than the 20 V or 40 V samples. However, a lower specific capacitance was obtained for the 60 V sample than for the 40 V sample because a large amount of carbon is incorporated into the 60 V sample. The 20 V sample showed a poor current response and poor capacitance in comparison to the 40 V and 60 V samples because of a thin layer of TiO₂ and small pore size after anodization of Ti together yield low carbon loading and poor ion transport. The visual appearance of the substrate anodized at 20 V showed little coverage of carbon across the entire substrate. This could imply that the initial anodization voltage is too low for structured and uniform nanopores and would limit the carbon modification. Carbon depositing out with these sections would not be particularly useful in charge storage applications which can explain the large mass difference and small specific capacitance per gram. The 40 V sample, while having a smaller current response than the 60 V sample, showed the greatest specific capacitance. This, however, can be due to the small mass of active material deposited. It is not fully understood why the mass of carbon loaded is so small; it can simply be due to the difference in the retention time for gas molecules caused by the substrate positioning within the crucible. These results suggest that an anodization voltage of 40-60 V is the best for maximizing the double layer charging capacitance.

The Fe precursor is one of factors that should be controlled in order to optimize the double layer charging capacitance and redox reaction activities. Submersion of the anodized TiO₂ substrate in a 1M Fe(NO₃)₃ solution would be satisfactory to allow physical adsorption of Fe ions onto the surface of the TiO₂ template. Fe ions get reduced by hydrogen and converted to Fe nanoparticles to help break down CH₄ to C and H₂. Carbon modification in the CH₄ and H₂ mix gas was expected to be quite efficient because the mass transfer of gas molecules from the gas mixture was expected to be efficient in the porous TiO₂ substrate. Carbon atoms and hydrogen are expected to be used to dope the anodized TiO₂ template while excess C remains attached to the surface of TiO₂. However, optimal growth still relies on control of the TiO₂ pore size and template thickness. In addition, it was believed that the presence of eddies and turbulent flow on the bottom of the sample lead to a greater retention time of the gas mixture on the bottom compared to the top of the sample. This was resolved by arranging the substrates horizontally so that both sides of the substrate were exposed to the atmosphere before covering the quartz boat with two quartz plates. This forced turbulent flow of the incoming gas mixture within the quartz boat on both sides, leading to a greater retention time of gas within the boat and ensured ample time for carbon doping into both sides of the TiO₂ substrate. The double-layer charge storage response of each of the substrates treated under various conditions for Fe catalyst loading was studied. The largest current response and, subsequently, the largest specific capacitance per gram were achieved for the substrate immersed in the 10 mM carboxyferrocene solution. The specific capacitance in these samples in particular appreciably outperformed the other techniques of catalyst loading. The presence of the carboxylic acid group provides a way for the catalyst to covalently bond to the surface of the TiO₂, which increases the chance of a uniform monolayer of Fe catalyst forming. The uniformity of the Fe layer improves the mass transfer during carbon modification and leads to more uniform carbon deposition on the surface of the substrate. This has the effect of having a larger double layer area and, subsequently, a larger specific capacitance. Irradiating the Fe(NO₃)₃-dipped electrodes has the effect of photoreducing the Fe²⁺ ions into solid Fe particles on the surface of the TiO₂ template. This is a more reliable method of Fe deposition than submersion alone, as it ensures that Fe particles are deposited uniformly over the surface of the substrate (provided the UV lamp can fully cover the substrate). Table 1 summarizes the specific capacitances that were measured for the C-doped Ti oxide samples under various conditions, including the anodization voltage of the TiO₂ template, and the different methods used for Fe catalyst loading. The specific capacitance was calculated using both the anodic current and the cathodic current of their CVs, and the mean specific capacitance was obtained. The best voltage for charge storage was found to be 40 V, which might provide the best porosity and excellent electrode conductivity after carbon modification so that both charge storage capacity and mass transfer are optimal.

Ferrocene carboxylic acid is the best precursor for Fe catalyst loading because of the formation of a self assembled monolayer of this ferrocene derivative on the metal oxide surface. Such attachment is important to stabilize the Fe during rinsing of the substrate and to decrease the aggregation of Fe clusters during carbon modification so that even surface coating/doping can be achieved.

TABLE 1
Mass difference and the resulting capacitance per gram of substrates
anodized at different voltages and Fe precursor loading methods.

| Anodization | | Mass | +C¹ | −C² | Mean C |
|---|---|---|---|---|---|
| voltage | Fe precursor | (mg) | (F/g) | (F/g) | (F/g) |
| 20 | Fe(NO₃)₂ | 4.7 | 0.25 | 0.38 | 0.32 |
| 40 | Fe(NO₃)₂ | 0.9 | 10.03 | 13.79 | 11.91 |
| 60 | Fe(NO₃)₂ | 2.8 | 8.14 | 11.71 | 9.92 |
| 40 | Fe(NO₃)₂ | 0.8 | 4.25 | 5.57 | 4.91 |
| 40 | Carboxyferrocene | 2.3 | 12.96 | 18.58 | 15.77 |
| 40 | Fe(NO₃)₂ + UV | 0.8 | 4.63 | 6.88 | 5.76 |

¹Calculated from cathodic current and divided by mass
²Calculated from anodic current and divided by mass

Double Layer Charge Storage Performance of Nano-COT Electrodes with a Symmetric Geometry

To test how the double layer charging of Nano-COT would behave in a symmetric double layer configuration, two Nano-COT electrodes were placed in a 1M NaOH solution in parallel so that the charge storage performance of the two electrode device could be tested. As shown in FIG. 10, the voltage was scanned at rate of 250 mV/sec and the current remained stable between 0.1 V and 1.2 V. Further increase in the applied potential was found to cause oxidation of the electrodes and electrolysis of the electrolyte. Therefore, the Nano-COT electrode has a maximum operating voltage of 1.2 V, which is better than that for a pure carbon electrode; this is due to the high electrochemical stability of these C doped Ti oxide electrodes.

### Electrogenerated Chemiluminescence (ECL) at Nano-COT Nanostructured Electrode.

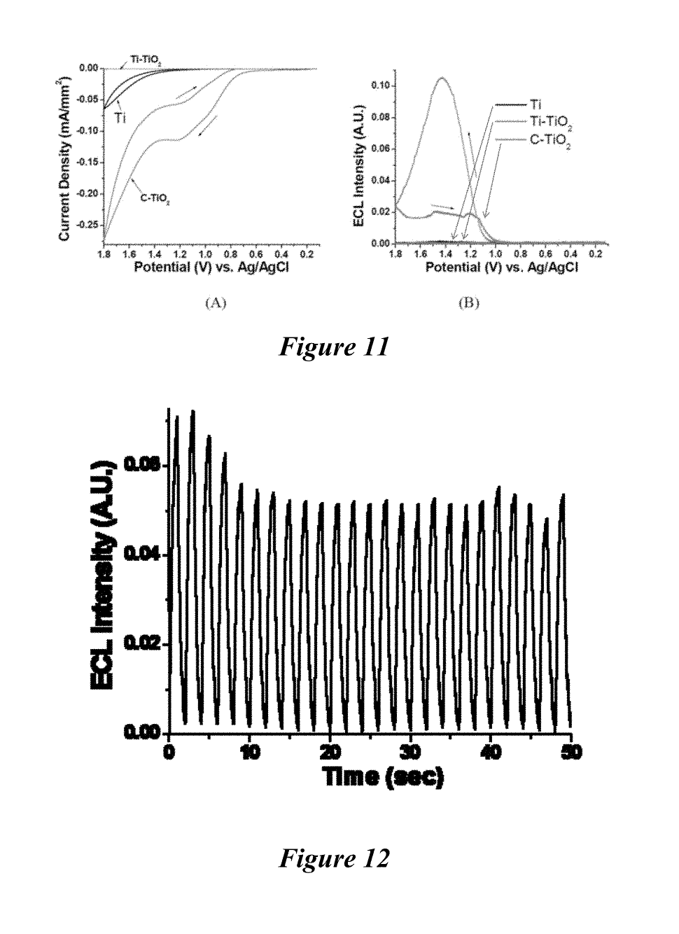

To avoid large background current while still having redox properties detected at high sensitivity using the highly conductive Nano-COT nanostructured electrode, ECL of Ru(bpy)₃²⁺ was generated at the new electrode in the presence of a coreactant. ECL of Ru(bpy)₃²⁺ can be generated at a working electrode by Ru(bpy)₃³⁺, generated through oxidation of Ru(bpy)₃²⁺, and Ru(bpy)₃¹⁺, from reducing Ru(bpy)₃²⁺ in the presence of a highly reducing species produced from coreactant tripropylamine (TrPA). FIG. 11 shows the CV and ECL spectra of Ru(bpy)₃²⁺ obtained at the Nano-COT electrode. In comparison to anodized Ti and bare Ti electrodes, ECL of Ru(bpy)₃²⁺ starts to take place at 0.9 V (vs. a Ag/AgCl reference electrode) and peaks at 1.4 V, while no ECL is observed at the anodized Ti plate due to the poor conductivity of the thick TiO₂ layer. There is no ECL generation at the Ti planar electrode because of the sluggish kinetics of the coreactant TrPA. The observed ECL turn-on potential is close to that of a gold electrode and a Pt electrode. The ECL intensity per geometric area at Nano-COT is presumably higher than at planar gold and Pt electrodes because of the efficient mass transfer of the redox species and the high real surface area of the nanostructured electrode. In comparison to CV, which has large background current due to the double layer charging, the ECL response curve at Nano-COT shows zero background, as the collected ECL signal is only sensitive to specific redox reaction of ECL active species (e.g., Ru(bpy)₃²⁺) at the nanostructured electrode without being obscured by double layer charging current. This experiment indicates that Nano-COT could be used to replace noble metal electrode materials as a new platform for ultrasensitive sensing based on ECL technique. Pulsed ECL response at the Nano-COT electrode shows stable light emitting feature, as shown in FIG. 12.

### Water Oxidation Performance at the Nanostructured Nano-COT Electrodes.

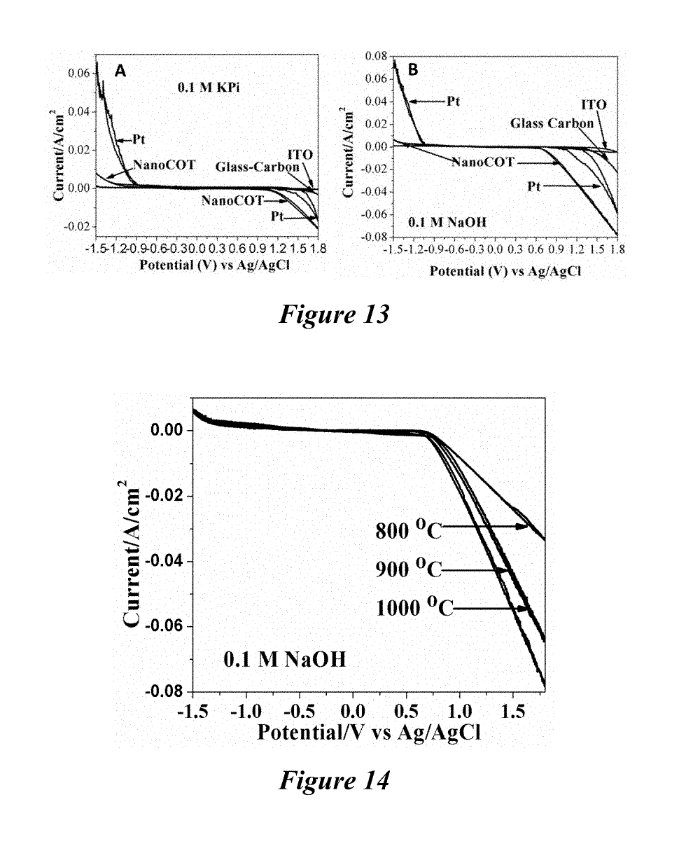

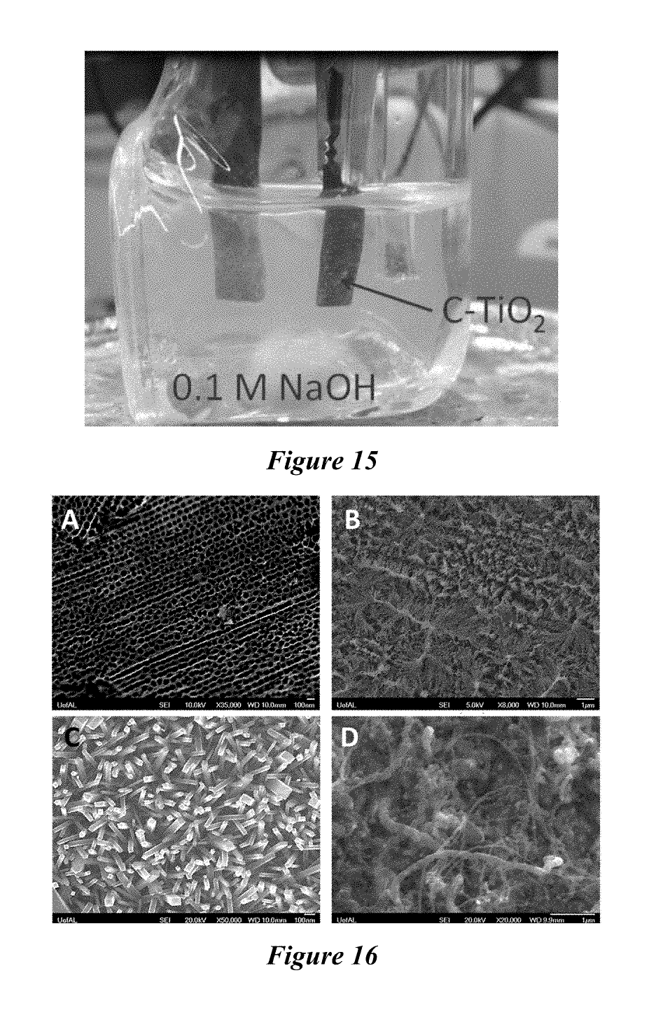

The above mentioned enormous charge storage and catalytic properties of the new Nano-COT electrodes with nanostructured surfaces is attributed to enhanced surface area and/or improved surface charge transfer rate. The electrodes' capability for use in the water splitting reaction, which is essential for hydrogen generation with solar energy or decreased cost of electrolyzer containing Pt, was also tested. As shown in FIG. 13, enhanced current density for water oxidation can be obtained for Nano-COT in contrast to ITO and glassy carbon. Furthermore, the current density for the Nano-COT is higher than that of planar Pt for water oxidation. The results were the same for when PBS buffer or NaOH was used as the electrolyte. In the reduction site, Pt shows much better proton reduction activity than Nano-COT due to the catalytic inner sphere reaction towards proton reduction. Nano-COT is still much better than ITO and glassy carbon electrode. FIG. 14 shows the CVD temperature dependence of the water oxidation current density, indicating a high CVD temperature above 800° C. is needed in order to form the conductive high surface area nanostructured electrode. FIG. 15 shows a photon of splitting water using Nano-COT as anode material. Better performance than planar Pt can be obtained at the nanostructured Nano-COT electrode because of its high surface area and catalytic activity for the water oxidation reaction.

In summary, the fabrication and electrochemical performance of a highly conductive nanostructured Nano-COT electrode was presented. Improvements to the redox reaction activity (e.g., water splitting) and double layer charge storage capacitance can be obtained by eliminating the TiO₂ barrier layer between the Ti substrate and solution, and modifying the oxide substrate with carbon. Optimal double layer capacitance can be obtained at an anodization voltage of 40 V. The specific capacitance of Nano-COT made with ferrocene carboxylic acid was found to have optimal conductivity and charge storage capacity. Ferrocene carboxylic acid can bind more strongly to the TiO₂ substrate forming a more uniform Fe layer, improving mass transfer during the thermal reduction of TiO₂ in the presence of hydrogen and carbon. A symmetric double layer charge storage device is formed by combing two Nano-COT electrodes and the device had an operation voltage up to 1.2 V. ECL studies showed that Nano-COT is an electrochemically stable electrode for ECL generation and it can be used to replace noble metal electrodes without being obscured by double layer charging current for ultrasensitive ECL sensing. Water splitting reactions showed Nano-COT can replace the Pt anode.

### Example 2

### Methods

### NanoCOT Electrode Based on Nanostructured Ti by Hydrothermal Reaction

Instead of anodizing Ti substrates in fluorine-based electrolyte to form a porous TiO₂ film (FIG. 16A) prior to converting it to a nanostructured NanoCOT (FIG. 16B) as described in Example 1, another method was also used to produce nanostructured Ti electrodes for NanoCOT electrodes. Ti substrates were first cleaned with acetone in an ultrasonic bath for 20 min, and then rinsed with a large amount of water. After drying in air, all substrates were chemically etched in HCl solution to remove the oxide layer naturally formed in air to provide a fresh Ti surface for the hydrothermal reaction. All Ti plates were then loaded into a Teflon-lined stainless steel autoclave filled with 2.5 wt. % HCl aqueous solution, and kept at 190° C. for 12 h to complete the hydrothermal reaction to produce nanostructured Ti surface (FIG. 16C) containing high coverage of Ti nanowires. The as-prepared Ti substrates were then annealed at 450° C. for 10 h to form a thin TiO₂ shell layer on Ti prior to the CVD treatment for transforming the electrode to NanoCOT (FIG. 16D).

### Synthesis of NiMoZn/NanoCOT

The electrodeposition of NiMoZn was used according to the method reported by Daniel Nocera (Nocera DG. Acc. Chem. Res. 2012, 45, 767-776). The NiMoZn cathode was electrodeposited from a solution of nickel(II) chloride hexahydrate (9.51 g L⁻¹), sodium molybdate dihydrate (4.84 g L⁻¹), anhydrous zinc chloride (0.0409 g L⁻¹), tetrabasic sodium pyrophosphate (34.57 g L⁻¹) and sodium bicarbonate (74.77 g L⁻¹). Hydrazine hydrate (1.21 mL L⁻¹) was added immediately before plating. The NiMoZn alloy was deposited at a potential of −1.5 V vs. Ag/AgCl for 20 min. The obtained electrodeposited film was then kept in 10M KOH to leach for >16 hours to obtain suitable stoichiometry for enhanced proton reduction. Successful leaching was indicated by bubbles evolving from the electrode surface. After leaching, the deposit became slightly darker in appearance

### Characterization and Electrochemical Analysis

Nanostructure morphologies and high resolution images were characterized with a JEOL 7600F field emission scanning electron microscope (SEM). Transmission electron microscopy (TEM) samples were prepared by removing the NanoCOT nanostructures from the Ti substrate by scraping with a razor blade and suspending them in DI water prior to being transferred onto a 200 mesh copper grid. The samples were then imaged using a FEI Tecnai F-20 transmission electron microscope (TEM). X-ray photoelectron spectroscopy (XPS) was performed using a Kratos XIS 165 system. Absorbance spectra were measured using a Varian Cary 50 UV-Vis spectrophotometer. XRD patterns were obtained using a Bruker D2 phaser diffractometer.

All the electrochemical analyses were measured in 0.1M KOH in a three-electrode cell using a CHI 760C potentiostat at a rate of 5 mV/s. An electrochemical cell was comprised of a NanoCOT as its working electrode, a graphite rod counter electrode, and a Ag/AgCl reference electrode filled with saturated KCl solution. Polarization curves for water oxidation were compared with IrOₓ and Pt wire electrodes to determine the relative oxygen evolution reaction performance of the NanoCOT electrode. A two electrode system was comprised of an anode (chosen from NanoCOT, IrOₓ wire or Pt wire) and a cathode of NiMoZn/NanoCOT was constructed to show the performance of electrolysis of water at various combinations of the two electrodes. The electrodes distance was 1.6 cm and scanning rate 5 mV/s. The electrochemical conductivities of NanoCOT were also characterized in 1.0M Na₂SO₄ containing 5.0 mM Ru(NH₃)₆Cl₂. Electrochemical impedance spectra (EIS) of samples were measured at DC potential of 0 V vs. Ag/AgCl and an AC potential frequency range of 10000-0.1 Hz with an amplitude of 10 mV in 0.1M KOH electrolyte. A commercially free software (ZsimpWin) was used for fitting the experimental EIS data.

### Results and Discussion

### Water Hydrolysis Performance

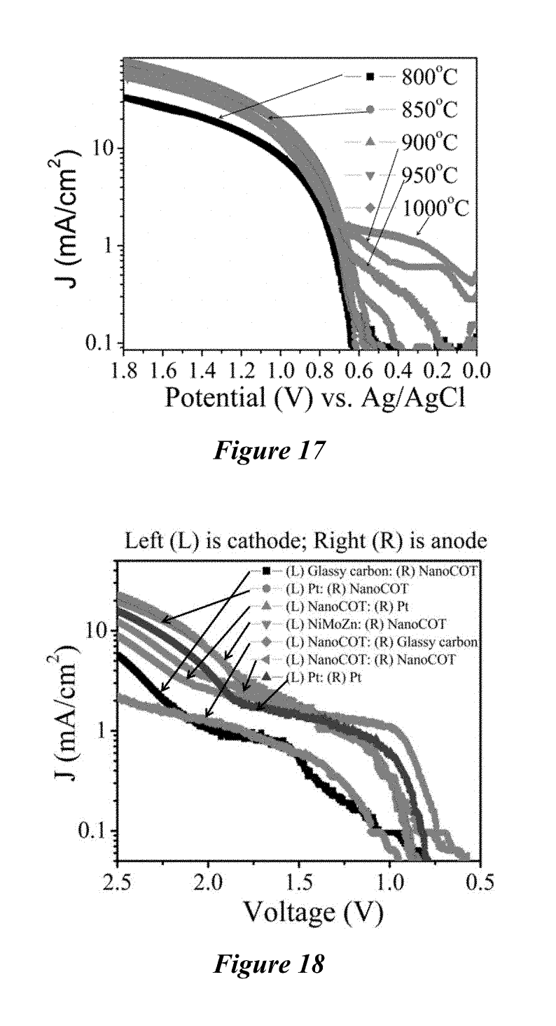

The results of the polarization experiment of Nano-COT obtained by hydrothermal reaction suggests that the anodic current per geometric surface area at the NanoCOT anode is highly active for OER in alkaline solution, in contrast to commercial standard electrode materials such as glassy carbon and indium-tin-oxide (ITO) electrodes. The turn-on potential of OER on NanoCOT is 0.6 V vs. Ag/AgCl in 0.1M NaOH, which is comparable with Pt. The current density of NanoCOT reaches 80 mA/cm² and is 30% higher than the current density of planar Pt electrode at 1.8 V vs. Ag/AgCl (60 mA/cm²). Moreover, the current densities of the glassy carbon and ITO electrodes were about 20 mA/cm² and 4 mA/cm², respectively, which are much lower than the NanoCOT electrode at the same electrode potential. To optimize the OER performance, the CVD temperature dependence of the water oxidation reaction in 0.1M KOH was also investigated (FIG. 17). The current density of the NanoCOT obtained at 800° C. is as low as 9 mA/cm² at 2 V vs. RHE. The maximal activity was observed for the electrode treated in CVD at 900° C., which achieved a current density of 20 mA/cm². Temperatures higher than 900° C. lead to a decreased current density. Thus, the temperature for carbon transformation was chosen to be 900° C. to achieve the NanoCOT electrodes.

Proton reduction is sluggish at the NanoCOT cathode, in contrast to the Pt electrode. To overcome this issue, the NanoCOT electrode was coated with NiMoZn electrochemically. Better proton reduction efficiency was achieved with the NiMoZn modified NanoCOT electrode than the bare NanoCOT. In order to compare these electrodes in overall water splitting application, a cell was set up and the different materials were used as the cathode or anode to compare with each other. FIG. 18 shows the linear sweep voltammetry curves of the different pairs of electrodes for complete water electrolysis. The combination of NiMoZn-NanoCOT (cathode) and NanoCOT (anode) exhibited the highest current density (120 mA/cm²) at 5 V and the lowest turn-on voltage (near 1.5 V).

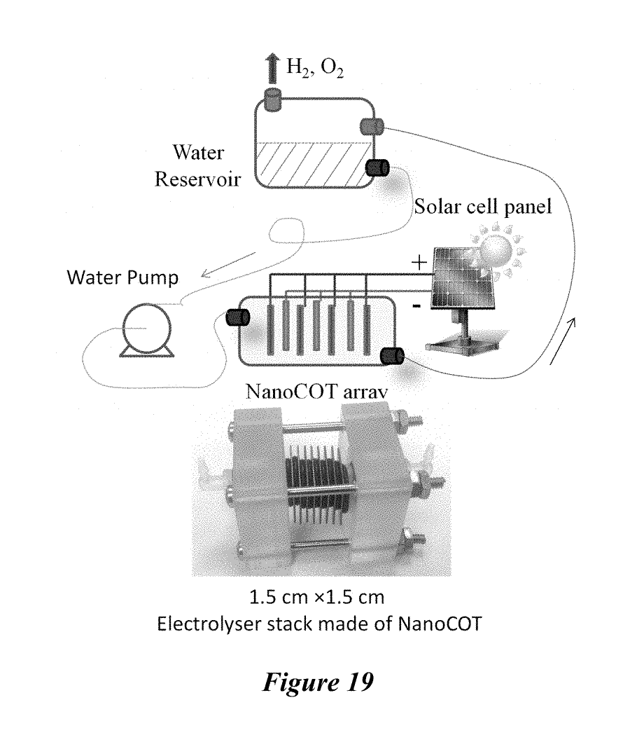

A scaled up system for water electrolysis using Nano-COT is shown in FIG. 19, where an automatic water flow system can feed an electrolyzer stack made of a NanoCOT electrode array for splitting water to produce hydrogen. The electrolyzer can be powered by a commercial solar cell panel while a water reservoir can be used to hold the water supply and gas collection. The NanoCOT electrode can be a 5″×5″ square. A large volume autoclave can be used for the hydrothermal reaction to produce the nanostructured Ti surface, and an automatic CVD system can be used for the carbon transformation. A large turn-key CVD system can be used to perform the carbon doping. A 2.6 gallon non-stirred pressure vessel can be used to accommodate the scaled up NanoCOT electrode production. The reactor can have a single valve assembly, gas release valve, 2000 psi pressure gage, 2000 psi rupture disc, and thermowell with thermocouple to provide safe production of the electrode materials needed for the water splitting reaction. A commercial solar cell can be used as a power supply to demonstrate the capability of the NanoCOT electrolyzer stack to efficiently produce hydrogen gas. The long-term stability of the prototype system will be tested for large scale production and commercialization. Seven NanoCOT stacks arranged in parallel, as shown in FIG. 19, can produce 1 L of hydrogen at STP with a current density of 840 mA/cm² at 5 V. The energy efficiency of the electrolyzer stack can be higher than other commercial metal alloy electrodes (other than platinum) because of the enhanced stability and catalytic performance, as well as the high surface area, of the NanoCOT electrode.

### Structural Analysis

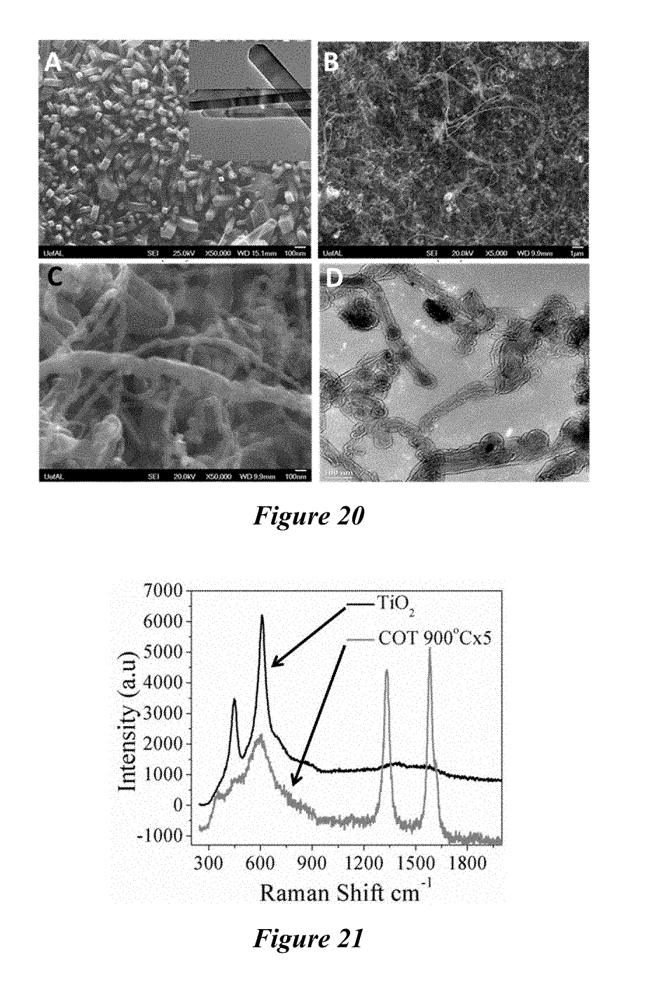

Microscopic structure changes and the electrochemical performance of the Nano-COT obtained via hydrothermal reaction were studied. The Ti nanowires obtained via hydrothermal reaction retain their wire structure as shown in FIG. 20. Ti@TiO₂ nanowires with diameters varying from 50 to 100 nm and lengths of up to 500 nm, such as those in FIG. 20A, have been synthesized. The thickness of the oxide layer was estimated from high resolution TEM to be a few nanometers, but varies from wire to wire. FIGS. 20B and C show a top-view SEM image of the NanoCOT after CVD reaction at 1000° C. The surfaces of the carbon doped nanowires are covered by carbon nanotubes with diameters around 80 nm (FIG. 20D).

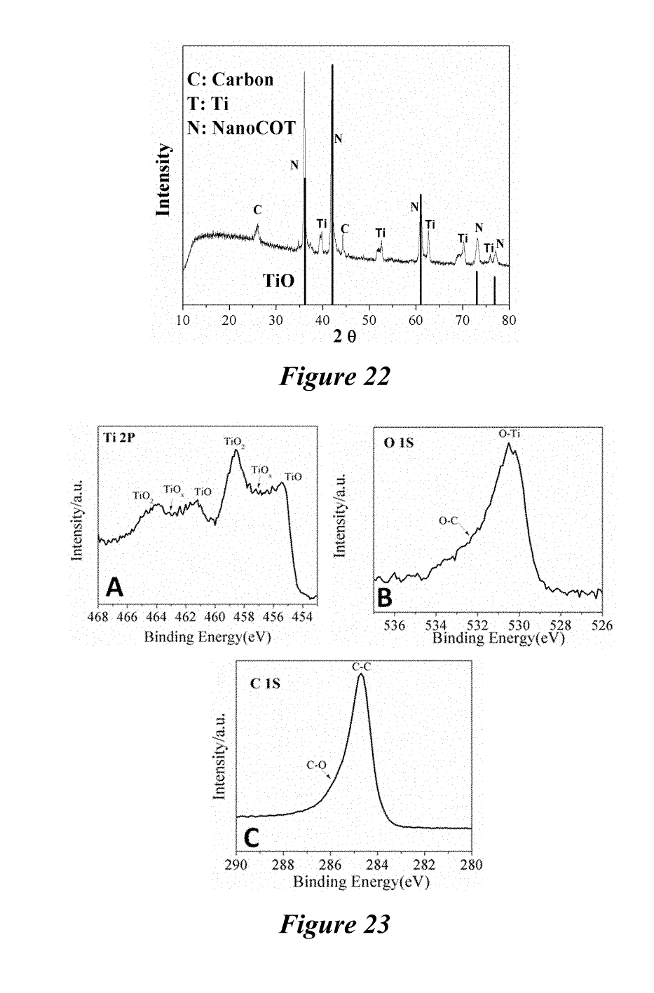

The features of Ti nanowires after C modification is not quite clear in the Raman spectra due to the dramatic changes in its electronic structure and composition. After carbon modification, the main Raman lines corresponding to the D and G bands of carbon can be detected (FIG. 21). This implies that there are still trace amounts of the carbon that was deposited onto the NanoCOT substrate during the thermal annealing in the presence of methane and hydrogen. XRD of the NanoCOT (FIG. 22) shows the electrode is isostructural with TiO. As the labeled index of the TiO, the peaks around 36.1°, 42°, 61°, 73° and 76.9°, correspond to the <111>, <200>, <220>, <311> and <222> phases, respectively. The XPS analysis of the electrode (FIG. 23) shows that the NanoCOT is a solid solution of C and TiO₂₋ₓ (0<x<1). The TiO₂₋ₓ is a mixture of Ti⁴⁺, Ti³⁺ and Ti²⁺ oxide because hydrogen and methane partially reduced the TiO₂ to a lower valance state. There are no Ti—C or carbonate peaks (around 282 eV or 288 eV, respectively) present in C 1S XPS data. However, both the C 1S and O 1S XPS data show the presence of a C—O bond, indicating that the carbon atoms do not replace O to form a Ti—C bond, nor do the carbon atoms replace Ti to form a Ti—O—C carbonate bond in the NanoCOT. Instead, carbon atoms are inserted into the space in the TiO₂₋ₓ lattice and bond with O atom as a solid solution of C and TiO₂₋ₓ.

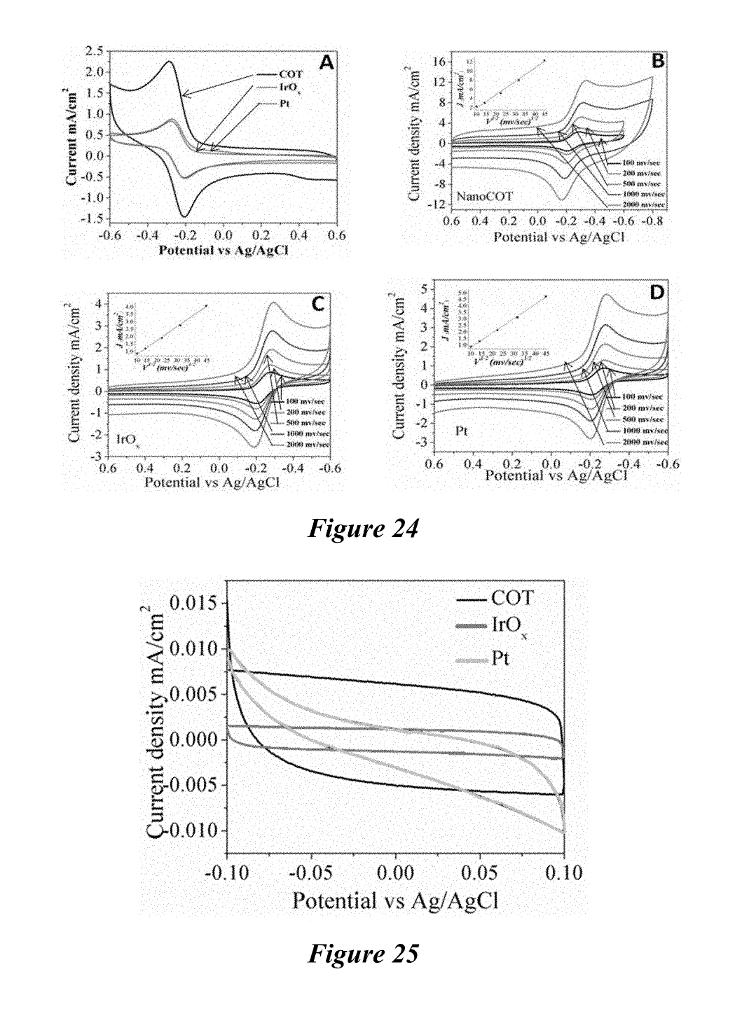

The conductivity performance of the obtained NanoCOT electrode was investigated using dynamic control of the electrode potential in the presence of the common reversible redox species Ru(NH₃)₆³⁺ and compared with the redox behavior of Pt and IrOₓ wire electrodes (FIG. 24A). The NanoCOT electrode showed pronounced reversible redox behavior for the redox species and its performance was comparable with than of the Pt and IrOₓ wire electrodes. These results indicate that the NanoCOT electrode is highly conductive for reversible redox reaction, similar to a noble metal electrode. The NanoCOT electrode (FIG. 24B) shows a linear increase in the redox reaction peak current with square root of scan rate, as do IrOₓ and Pt wire electrodes (FIGS. 24C and D, respectively), indicating the reversible reaction characteristics of the redox reaction at the electrodes and linear mass transfer features of redox species at the NanoCOT electrode during the range of applied scan rates. The faradaic current density at the NanoCOT electrode is higher than at the IrOₓ and Pt electrodes. This can be explained by the fact that the geometric surface area plays a major role at slow scan rates, which produce a thick redox diffusion layer of redox molecules so that the nanostructured surface has no contribution to the overall mass transfer process. The double layer charging current density at the NanoCOT electrode is twice that of the Pt wire electrode and 4 times more than the IrOₓ wire electrode due to the high conductivity, surface area and carbon modified nano-structure (FIG. 25).

### Additional Water Hydrolysis Performance Comparison to IrOₓ and Pt Electrodes

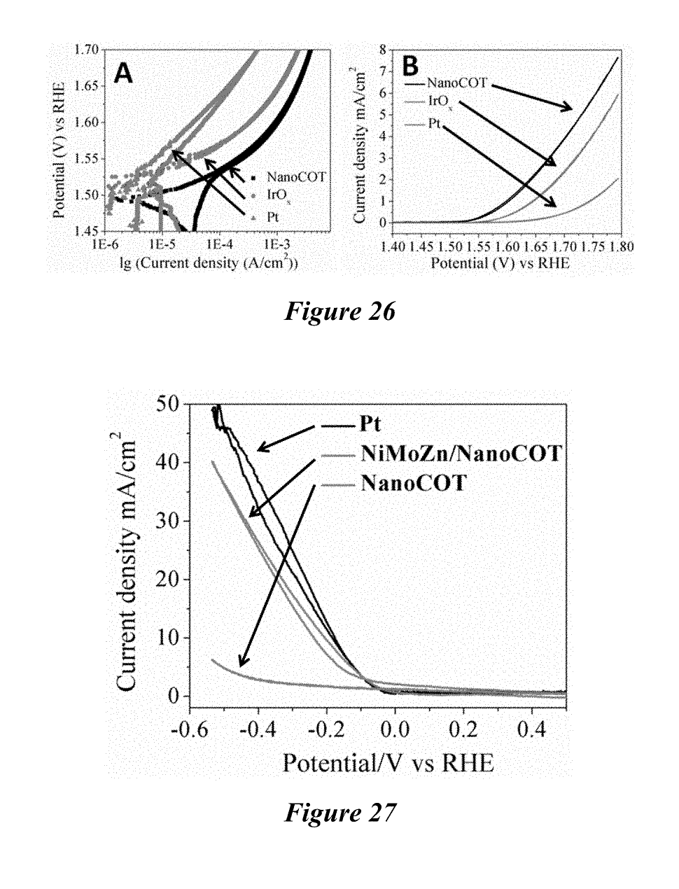

The polarization experiment results (FIG. 26) suggest that the anodic current per geometric surface area at the NanoCOT electrode anode is highly active for OER in alkaline solutions, in contrast to noble metal materials such as IrOₓ and Pt electrodes. The turn-on potential of OER at the NanoCOT electrode is 1.5 V vs. RHE in 0.1M KOH, which is comparable with IrOₓ and Pt (FIG. 26A). FIG. 26B shows that the current density of the NanoCOT electrode reaches 90 μA/cm², which is 10 times higher than the 9.4 μA/cm² of the IrOₓ wire and 25 times higher than the 4 μA/cm² of the Pt wire electrode at 1.53 V vs. RHE. Proton reduction is sluggish at the NanoCOT cathode, in contrast to the Pt electrode. To overcome this issue, the NanoCOT electrode was coated with NiMoZn electrochemically. Better proton reduction efficiency was achieved with the NiMoZn modified NanoCOT electrode than with the bare NanoCOT (FIG. 27).

### AC Impedance

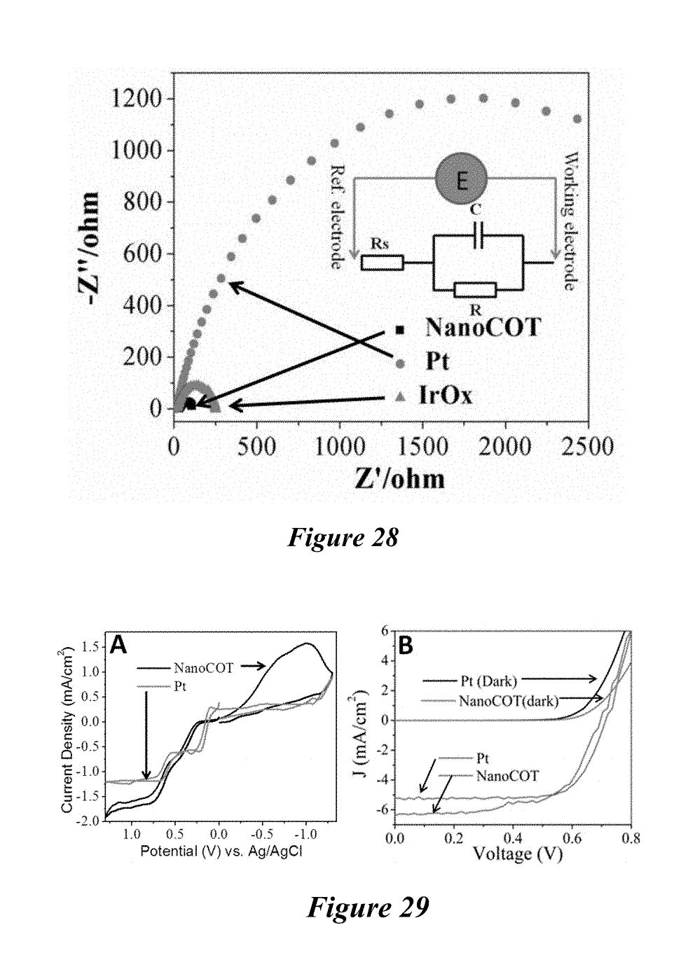

To elucidate the OER kinetics or charge transfer process and to obtain more quantitative information about the electrodes, electrochemical AC impedance spectroscopy (EIS) was performed. FIG. 28 shows the typical Nyquist plots of the NanoCOT, IrOₓ and Pt at 1.63 V vs. RHE (geometric surface area 0.5 cm²). All impedance spectra are fitted using an equivalent RC circuit model, shown in FIG. 28, comprised of a resistor (Rₛ) representing the resistivity of the electrolyte between the working and reference electrode, a charge transfer resistance (R) representing the charge transfer resistivity between the catalyst and electrolyte, and a capacitance (C) in parallel with the (R) analogous to the double layer charging capacity of the solid-liquid junction. All fitting results are summarized in Table 2. There were no major differences in the Rₛ of the three different electrodes. The R of the NanoCOT is 66Ω, which was found to be much lower than that of IrOₓ (210Ω) and Pt (2300Ω). Moreover, the capacitance is also different due to the differences in their chemical composition and real surface area. The NanoCOT showed the largest C (˜1000 μF) because of the deposited graphite on the surface and its nano surface structure, whereas of IrOₓ and of Pt had C values of 20 μF and 90 μF, respectively.

TABLE 2
AC impedance parameters obtained by fitting
the experimental data fitting.

| | NanoCOT | IrOₓ | Pt |
|---|---|---|---|
| Rₛ (Ω) | 34 | 22 | 18 |
| R (Ω) | 66 | 210 | 2300 |
| C (μF) | 1000 | 20 | 90 |

### Example 3

Experiments also indicate that there is a dramatic increase in double layer charging current density at the NanoCOT electrode prepared using the hydrothermal reaction in comparison to a bare gold disc electrode. This can be explained by fast ion diffusion and migration near the nanostructured electrode, which has a much larger surface area than a planar gold electrode, under applied potential in a strong electrolyte. Nanostructuring of the electrode causes much thinner diffusion layers of ions than gold planar electrode under condition of high ionic strength so that it can produce much greater double layer charging capacitance than a bare gold electrode. This would be potentially useful for developing capacitors and/or batteries based on the NanoCOT electrode materials. The double layer charging characteristics of two NanoCOT electrodes were tested in a symmetric configuration (FIG. 10). These two electrodes arranged in parallel in an electrochemical cell showed excellent stability between 0.1 V and 1.2 V. The measurements show that the average specific capacitance of NanoCOT electrode is as high as 11.91 F/g in 0.1M NaOH. This is a large improvement over the 0.29 F/g calculated for the annealed Ti substrate before carbon transformation. In addition to application in charge storage, the NanoCOT can also be used as a counter electrode in a dye sensitized solar cell to cycle the redox reaction of the hole transport mediator of iodine. A solar cell of TiO₂ sensitized with cis-bis(isothiocyanato)bis(2,2′-bipyridyl-4,4′-dicarboxylato)-ruthenium(II) dye (N3, Solaronix, Switzerland) was assembled with NanoCOT as its counter electrode to cycle the iodine electrochemistry (FIG. 29). In comparison with a Pt sputtered FTO counter electrode, the cell with the NanoCOT counter electrode provides equivalent short-circuit current iₛₛ and open-circuit voltage V_{oc} as well as good filling factor under 1 Sun illumination conditions. This shows that NanoCOT holds the promise to replace Pt as a counter electrode in solar cell fabrications.

### Example 4

Synthesis and Characterization of a COT Powder Catalyst (Powder COT)

Titanium dioxide particles (100 mg, Degussa P-25), Pluronic P-123 (20 mg), and poly(methyl methacrylate) (20 mg, PMMA were added to 30 mL of a 3 mM Fe(NO₃)₃ acetone solution and stirred for 5 hours at 600 rpm at room temperature in a capped beaker. The resultant Fe and surfactant modified TiO₂ particles were centrifuged and the precipitate was ground in a mortar. The resulting powders were then placed into a quartz boat, the boat's top was covered by quartz plates, and calcined at 450° C. in air in a tube furnace for 60 min to remove the surfactant species. After calcining in air, N2 gas was used to purge any 02 within the chamber of the furnace. The modified TiO₂ particles then underwent the carbon modification process as described herein above.

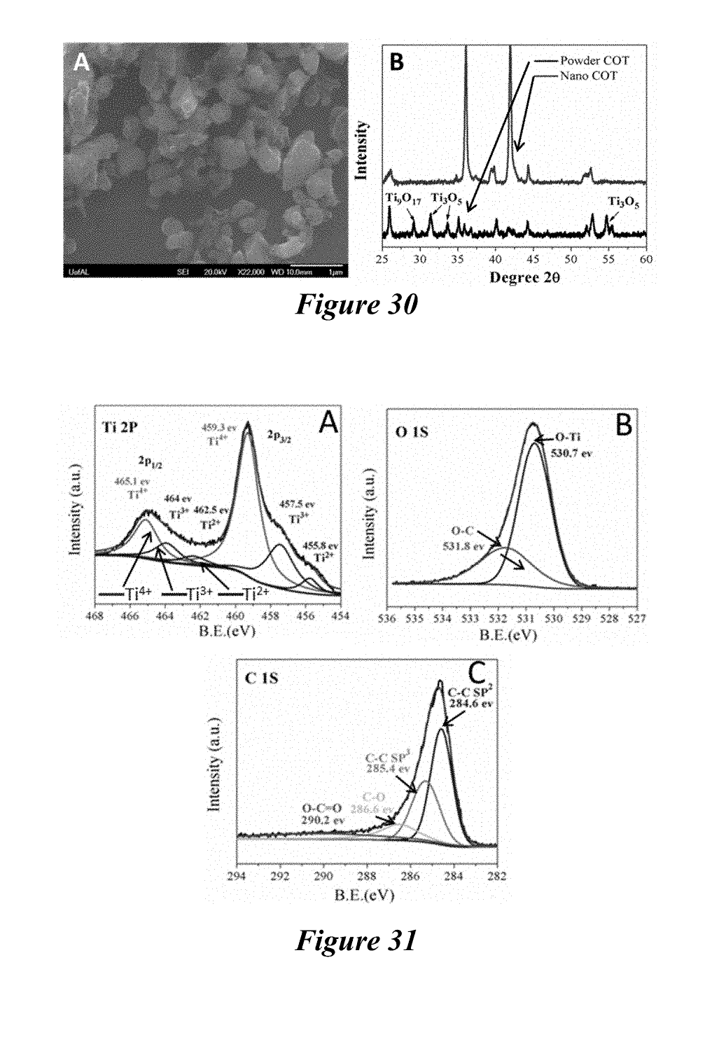

After undergoing the carbon modification at 900° C., the particles of the Powder COT sample were mostly agglomerated and with an average sizes around 1 μm (FIG. 30A). The BET surface area of the Powder COT sample was 2.3 m²/g. The XRD patterns of the Powder COT sample were similar to the Nano-COT plate sample (see above), but showed less crystallinity and smaller contributions from the TiO and Ti₂O₃ phases (FIG. 30B). The XRD of the Powder COT sample further displayed five peaks (around 29°, 31°, 33°, 54° and 55°) not observed for the Nano COT (FIG. 30B). These five peaks can be attributed to the formation of other reduced titanium oxide phases, such as Ti₉O₁₇ (at 29°) and Ti₃O₅ (at 31°, 33°, 54° and 55°), as indicated in FIG. 30B.

The chemical states of the O, Ti, and C in the Powder COT sample were investigated by XPS analysis (FIG. 31). The chemical composition of Powder COT sample was similar to the Nano COT sample (see above). The XPS results for the Ti states of the Powder COT sample displayed three doublet peaks corresponding to three chemical states of Ti, namely, Ti²⁺/TiO(Ti 2p_{3/2}, 455.8 eV; Ti 2p_{1/2}, 462.8 eV), Ti³⁺/Ti₂O₃ (Ti 2p_{3/2}, 457.5 eV; Ti 2p_{1/2}, 464 eV), and Ti⁴⁺/TiO₂ (Ti 2p_{3/2}, 459.4 eV; Ti 2p_{1/2}, 465.1 eV) (FIG. 31A). Compared to the XPS results of the Nano COT sample, the Ti²⁺ content in the Powder COT sample was lower than in the Nano COT sample, and the Ti⁴⁺ content was higher in the Powder COT sample than in the NanoCOT sample (FIG. 31A). The calculation of Ti atomic percentage based on the XPS of the Powder COT sample shows that the percentages of Ti²⁺, Ti³⁺ and Ti⁴⁺ are 8%, 27% and 65%, respectively (FIG. 31A). The XPS results for O showed an intense O is peak at ca. 530.7 eV (FIG. 31B), which can be attributed to the O²⁻ anions of the Ti—O bond. The XPS results for O showed another relatively lower peak at 531.8 eV (FIG. 31B), which can be assigned to the C—O bond. The results for the Powder COT sample showed a similar C—O content compared to the Nano COT sample, namely that about one third of the O atoms were bound to C. The XPS spectra for core level C is are shown in FIG. 31C. The major peak at 284.6 eV was assigned to external graphitic-like C—C SP² bonds, and the peak at 285.4 eV was attributed to diamond-like C—C SP³ bonds (FIG. 31C). The peaks at ca. 286.6 eV and 290.2 eV were ascribed to C—O and O—C═O bonds, respectively (FIG. 31C). Based on the XPS analysis results, the chemical formula of the Powder COT sample is about TiO_{1.9}:C_{0.3}.

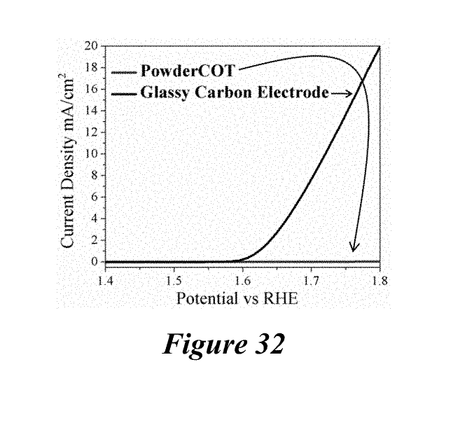

The OER catalytic characteristic of the Powder COT sample were also examined via a glassy carbon electrode loaded with the Powder COT sample. The OER onset potential of the Powder COT catalyst is around 1.55 V vs RHE (FIG. 32). The Powder COT catalyst sample generated a current density of 10 mA/cm² at a potential of 1.72 V vs RHE (FIG. 32), which is at least as good as, if not better, than the published nanostructured IrO₂ or other top level OER catalysts (such as Co₃O₄/N-rmGO, NF/PC/AN, Co/Mn/O, Zn/Co/LDH, or Mn₃O₄/CoSe₂ etc.), depending on the BET surface area.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible examples may be made of the invention without departing from the scope thereof, it is to be understood that all matter herein set forth or shown in the accompanying drawings is to be interpreted as illustrative and not in a limiting sense.

1. A method comprising:
forming a nanostructured electrode by:
a) thermally annealing a nanostructured titanium substrate;
b) contacting the nanostructured titanium substrate with an iron catalyst precursor to create an iron impregnated nanostructured titanium substrate; and
c) contacting the iron impregnated nanostructured titanium substrate with a working gas at a working temperature;
thereby creating the nanostructured electrode; and
using the nanostructured electrode in a water splitting reaction.

2. The method of claim 1, further comprising contacting a titanium substrate with an acid at an acid-contact temperature to form a nanostructured titanium substrate.

3. The method of claim 2, wherein the acid comprises an aqueous solution of HCl.

4. The method of claim 2, wherein the acid-contact temperature is 190° C.

5. The method of claim 1, wherein the nanostructured titanium substrate comprises a plurality of nanowires, nanotubes, or combinations thereof on the titanium substrate.

6. The method of claim 5, wherein the nanowires, nanotubes, or combinations thereof are from 50 to 100 nm in diameter, from 10 to 5 μm in length, or a combination thereof.

7. The method of claim 1, further comprising contacting a titanium substrate with an anodization solution and applying a potential to the titanium substrate to form a nanostructured titanium substrate.

8. The method of claim 7, wherein the anodizing solution comprises fluoride ions, ethylene glycol, or a combination thereof.

9. The method of claim 7, wherein the potential is from 20 to 60 V.

10. The method of claim 1, wherein the nanostructured titanium substrate comprises a plurality of nanopores in the titanium substrate.

11. The method of claim 10, wherein the pores have a diameter of 10-500 nm.

12. (canceled)

13. The method of claim 1, wherein the working gas is a hydrocarbon gas.

14. The method of claim 1, wherein the iron catalyst precursor comprises Fe(NO₃)₃, ferrocene carboxylic acid, or combinations thereof.

15. The method of claim 1, wherein the nanostructured electrode comprises titanium, carbon and oxygen.

16. The method of claim 1, wherein the nanostructured electrode comprises at least 3 atomic % carbon.

17. The method of claim 1, wherein the nanostructured electrode has a decreased oxygen content compared to TiO₂.

18. The method of claim 5, wherein the density of nanostructures on the nanostructured electrode is 1×10¹⁰ cm⁻².

19. The method of claim 1, wherein the double layer charging capacitance of the nanostructured electrode is 4800 μC/cm², wherein the specific capacitance of the nanostructured electrode is at least 5 F/g, or a combination thereof.

20. (canceled)

21. The method of claim 1, wherein the nanostructured electrode exhibits enhanced current density for water oxidation compared to planar Pt, ITO, and glassy carbon electrodes.

22. The method of claim 21, wherein the current density of the nanostructured electrode is: at least 30% higher than that of a planar Pt electrode; at least 4 times that of a glassy carbon electrode; at least 20 times that of an ITO electrode; or a combination thereof.
